(19) United States
(12) Patent Application Publication
(10) Pub. No.: US 2014/0037950 A1
(43) Pub. Date: Feb. 6, 2014

(54) PRESSURE-SENSITIVE ADHESIVE SHEET

(71) Applicants: Tatsumi Amano, Ibaraki-shi (JP); Yu Morimoto, Ibaraki-shi (JP); Kazuma Mitsui, Ibaraki-shi (JP); Kousuke Yonezaki, Ibaraki-shi (JP); Kyoko Takashima, Ibaraki-shi (JP)

(72) Inventors: Tatsumi Amano, Ibaraki-shi (JP); Yu Morimoto, Ibaraki-shi (JP); Kazuma Mitsui, Ibaraki-shi (JP); Kousuke Yonezaki, Ibaraki-shi (JP); Kyoko Takashima, Ibaraki-shi (JP)

(73) Assignee: NITTO DENKO CORPORATION, Ibaraki-shi (JP)

(21) Appl. No.: 14/111,335

(22) PCT Filed: Apr. 6, 2012
(86) PCT No.: PCT/JP2012/059527

§ 371 Date: Oct. 11, 2013

(30) Foreign Application Priority Data
Apr. 15, 2011 (JP) 2011-091485
Apr. 15, 2011 (JP) 2011-091503
Apr. 15, 2011 (JP) 2011-091509

(51) Int. Cl. G02B 1/10; C09J 7/02

(52) U.S. Cl. CPC G02B 1/105; C09J 7/0217
USPC 428/354

(57) ABSTRACT

The pressure-sensitive adhesive sheet includes a transparent film substrate; and, on at least one side thereof, an acrylic pressure-sensitive adhesive layer. The transparent film substrate includes a base layer including a resinous material and a top coat layer on a first face of the base layer. The top coat layer is formed from a polythiophene, an acrylic resin, and a melamine crosslinking agent and has an average thickness Dₐᵥₑ of 2 to 50 nm and a thickness variation ΔD of 40% or less. The acrylic pressure-sensitive adhesive layer is formed from a water-dispersible removable acrylic pressure-sensitive adhesive composition including an acrylic emulsion polymer.

### TECHNICAL FIELD

The present invention relates to removable pressure-sensitive adhesive sheets. Specifically, the present invention relates to removable pressure-sensitive adhesive sheets that have satisfactory visual quality, are resistant to clouding during storage under humid conditions, and are highly resistant to scratches and static electrification.

### BACKGROUND ART

Optical members (optical materials) may be represented by optical films such as polarizing plates, retardation films, and anti-reflective films. In production or working processes of them, surface-protecting films are laminated on surfaces of the optical members for the purpose typically of preventing surface flaw and stain, improving cutting workability, or suppressing cracking (see Patent Literature (PTL) 1 and 2). Removable pressure-sensitive adhesive sheets are generally used as the surface-protecting films. The removable pressure-sensitive adhesive sheets each include a plastic film substrate and, on a surface thereof, a removable pressure-sensitive adhesive layer.

For the surface-protecting films, solvent-borne acrylic pressure-sensitive adhesives have been used as a pressure-sensitive adhesive to form the pressure-sensitive adhesive layer (see PTL 1 and 2). These solvent-borne acrylic pressure-sensitive adhesives contain organic solvents that may adversely affect the coating working environment. To prevent this, attempts have been made to substitute water-dispersible acrylic pressure-sensitive adhesives for the solvent-borne acrylic pressure-sensitive adhesives (see PTL 3 to 5).

Such adherends (e.g., optical members) each laminated with a surface-protecting film have been increasingly subjected to a visual inspection with the surface-protecting film for satisfactory productivity. Typically from the viewpoints of the visual inspection and the inspection accuracy, the surface-protecting film requires visual quality at higher and higher level.

### CITATION LIST

### Patent Literature

PTL 1: Japanese Unexamined Patent Application Publication (JP-A) No. H11-961
PTL 2: JP-A No. 2001-64607
PTL 3: JP-A No. 2001-131512
PTL 4: JP-A No. 2003-27026
PTL 5: Japanese Patent No. 3810490

### SUMMARY OF INVENTION

### Technical Problem

Specifically, the surface-protecting film requires such a property as to be resistant to scratches on the surface (substrate surface) (this property is hereinafter also referred to as “scratch resistance”). This is because as follows. Suppose that a surface-protecting film laminated with an adherend (e.g., an optical member) has a scratch on its surface (substrate surface), and that the adherend is visually inspected with the surface-protecting film. In this case, it is difficult to determine whether a detected flaw is present on (derived from) the surface-protecting film or present on the adherend, and this lowers the adherend inspection accuracy.

There is known an exemplary technique for better scratch resistance of a surface-protecting film. This technique provides a hard surface layer (top coat layer) on a backside of the surface-protecting film so as to improve the scratch resistance of the backside. The term “backside” refers to the surface of the surface-protecting film, namely, a face (a surface of the substrate) opposite to the face (the pressure-sensitive adhesive layer surface) to be applied to the adherend.

However, the surface-protecting film bearing the top coat layer on the backside thereof, when applied to an adherend and is observed as intact from the backside, appears cloudy wholly or partially, and this disadvantageously causes poor visibility of the adherend surface. The observation may be performed typically in a bright room admitting outside light, or under a fluorescent lamp in a bright room. In addition, the top coat layer, if having a variation or variation in thickness, suffers from a difference in reflectance from one region to another and appears relatively cloudy in a thick region. This disadvantageously causes further poor visibility of the adherend surface. Such poor visibility of the adherend surface disadvantageously impedes the visual inspection of the adherend or lowers the inspection accuracy. To avoid these, demands have been made to provide a surface-protecting film that has a scratch-resistant top coat layer on a backside (substrate surface) thereof, does not appear cloudy wholly or partially, and has a satisfactory appearance.

Some surface-protecting films suffer from clouding (hygroscopic clouding) when applied to an adherend and stored as intact in a high-humidity environment (under humid conditions). This disadvantageously impedes the adherend inspection or lowers the inspection accuracy.

Surface-protecting films, when used typically in a working or transportation process of static-sensitive articles such as liquid crystal cells and semiconductor devices, also require such properties as to be resistant to static electrification (antistatic properties).

Accordingly, an object of the present invention is to provide a pressure-sensitive adhesive sheet as follows. The pressure-sensitive adhesive sheet includes a transparent film substrate having a top coat layer; and an acrylic pressure-sensitive adhesive layer present on at least one side of the film substrate, has satisfactory visual quality (less appears cloudy), is resistant to clouding during storage under humid conditions (hygroscopic clouding), is satisfactorily resistant to scratches and static electrification, and is removable.

### Solution to Problem

After intensive investigations to achieve the object, the present inventors have found that a specific pressure-sensitive adhesive sheet has excellent visual quality, is resistant to clouding during storage under humid conditions (hygroscopic clouding), and is satisfactorily resistant to scratches and static electrification; and that this pressure-sensitive adhesive sheet includes a transparent film substrate and, present on at least one side thereof, an acrylic pressure-sensitive adhesive layer, in which the transparent film substrate has a top coat layer having a specific structure with the average thickness and thickness variation being controlled, the acrylic pressure-sensitive adhesive layer is formed from a water-dispersible acrylic pressure-sensitive adhesive composition including an acrylic emulsion polymer as a component, and the acrylic emulsion polymer is polymerized from constitutive monomers in a specific formulation using a specific emulsifier. The present invention has been made based on these findings.

Specifically, the present invention provides a pressure-sensitive adhesive sheet including: a transparent film substrate; and an acrylic pressure-sensitive adhesive layer present on or over at least one side of the transparent film substrate, in which the transparent film substrate includes a base layer including a resinous material, and a top coat layer present on or above a first face of the base layer; the top coat layer is formed from a polythiophene, an acrylic resin, and a melamine crosslinking agent and has an average thickness Dₐᵥₑ of from 2 to 50 nm and a thickness variation ΔD of 40% or less; the acrylic pressure-sensitive adhesive layer is formed from a water-dispersible removable acrylic pressure-sensitive adhesive composition including an acrylic emulsion polymer; the acrylic emulsion polymer is derived from constitutive monomers including a (meth)acrylic alkyl ester (A) and a carboxyl-containing unsaturated monomer (B) as essential constitutive monomers; the constitutive monomers constituting the acrylic emulsion polymer include the (meth)acrylic alkyl ester (A) in a content of from 70 to 99.5 percent by weight and the carboxyl-containing unsaturated monomer (B) in a content of from 0.5 to 10 percent by weight, based on the total amount of the entire constitutive monomers; and the acrylic emulsion polymer is polymerized with a reactive emulsifier containing at least one radically polymerizable functional group per molecule.

The resinous material constituting the base layer may include a poly(ethylene terephthalate) or a poly(ethylene naphthalate) as a principal resinous component.

The water-dispersible removable acrylic pressure-sensitive adhesive composition may further include a water-insoluble crosslinking agent having two or more carboxyl-reactive functional groups per molecule, which carboxyl-reactive functional groups are capable of reacting with carboxyl group.

The acrylic emulsion polymer may be derived from constitutive monomers including: the (meth)acrylic alkyl ester (A); the carboxyl-containing unsaturated monomer (B); and at least one monomer (C) selected from the group consisting of methyl methacrylate, vinyl acetate, and diethylacrylamide as essential constitutive monomers.

The acrylic emulsion polymer may have a solvent-insoluble content of 70 percent by weight or more.

The acrylic pressure-sensitive adhesive layer may have a solvent-insoluble content of 90 percent by weight or more and an elongation at breaking point of 130% or less at 23° C.

The carboxyl-reactive functional groups of the water-insoluble crosslinking agent may be present in an amount of from 0.4 to 1.3 moles per 1 mole of carboxyl groups of the carboxyl-containing unsaturated monomer (B) in the water-dispersible removable acrylic pressure-sensitive adhesive composition.

Constitutive monomers constituting the acrylic emulsion polymer may include: 70 to 99 percent by weight of the (meth)acrylic alkyl ester (A); 0.5 to 10 percent by weight of the carboxyl-containing unsaturated monomer (B); and 0.5 to 10 percent by weight of the monomer (C), based on the total amount of the constitutive monomers.

The pressure-sensitive adhesive sheet may serve as a surface-protecting film for an optical member.

### Advantageous Effects of Invention

The pressure-sensitive adhesive sheet according to the present invention has the configuration, is thereby satisfactorily resistant to scratches and static electrification, less appears cloudy, and has excellent visual quality. The pressure-sensitive adhesive sheet is also resistant to clouding during storage under humid conditions (hygroscopic clouding). The pressure-sensitive adhesive sheet according to the present invention, when used as a surface-protecting film and even when applied to an adherend (e.g., an optical member) and subjected as intact to a visual inspection of the adherend, helps the visual inspection to be easily performed with better inspection accuracy. The pressure-sensitive adhesive sheet according to the present invention is particularly useful in surface protection of an optical film.

### DESCRIPTION OF EMBODIMENTS

A pressure-sensitive adhesive sheet according to an embodiment of the present invention has a transparent film substrate and, present on at least one side thereof, an acrylic pressure-sensitive adhesive layer. As used herein the term “pressure-sensitive adhesive sheet” also refers to and includes one in a tape form, namely, a “pressure-sensitive adhesive tape.” A surface of the acrylic pressure-sensitive adhesive layer of the pressure-sensitive adhesive sheet according to the present invention is also referred to as an “adhesive face.”

The pressure-sensitive adhesive sheet according to the present invention may be a double-coated pressure-sensitive adhesive sheet having adhesive faces as both surfaces thereof; or a single-coated pressure-sensitive adhesive sheet having an adhesive face as only one surface thereof. Above all, the pressure-sensitive adhesive sheet is preferably a single-coated pressure-sensitive adhesive sheet when used for adherend surface protection. Specifically, the pressure-sensitive adhesive sheet according to the present invention is preferably a pressure-sensitive adhesive sheet (single-coated pressure-sensitive adhesive sheet) having a transparent film substrate and an acrylic pressure-sensitive adhesive layer present on or over one side of the film substrate. Particularly from the viewpoint of the scratch resistance, a surface of the transparent film substrate opposite to the acrylic pressure-sensitive adhesive layer preferably serves as the surface of the top coat layer in the pressure-sensitive adhesive sheet (single-coated pressure-sensitive adhesive sheet).

Transparent Film Substrate

The transparent film substrate in the pressure-sensitive adhesive sheet according to the present invention has at least a base layer made from a resinous material; and an after-mentioned top coat layer present on or over a first face of the base layer. The transparent film substrate may have a structure (layered structure) having the top coat layer on only one side (first face) of the base layer; or a structure (layered structure) having the top coat layer on both sides (first face and second face) of the base layer. Among such structures, the transparent film substrate preferably has a structure having the top coat layer on only one side (first face) of the base layer, i.e., a multilayered structure of [(base layer)/(top coat layer)].

Base Layer

The base layer in the transparent film substrate is a film (thin-film) molded article made from a resinous material. Specifically, the base layer is preferably a resin film prepared by molding a resinous material of every kind into a film. The resinous material to form the base layer is preferably, but not limited to, such a resinous material as to give a resin film excellent in one or more of properties such as transparency, mechanical strength, thermal stability, water shielding properties, and isotropy. Specifically, the resinous material is preferably one including, as a principal component (resin component), any polymer selected typically from polyester polymers such as poly(ethylene terephthalate)s (PETs), poly(ethylene naphthalate)s, and poly(butylene terephthalate)s; cellulosic polymers such as diacetyl cellulose and triacetyl cellulose; polycarbonate polymers; and acrylic polymers such as poly(methyl methacrylate)s. The term “principal component” refers to a principal component of the resinous material, such as a component present in a content of 50 percent by weight or more, based on the total amount (100 percent by weight) of the resinous material. The resinous material is more preferably one including a poly(ethylene terephthalate) or a poly(ethylene naphthalate) as a principal component. The resinous material may include any of other polymers as a component. The other polymers are exemplified by styrenic polymers such as polystyrenes and acrylonitrile-styrene copolymers; olefinic polymers such as polyethylenes, polypropylenes, polyolefins having a cyclic or norbornene structure, and ethylene-propylene copolymers; vinyl chloride polymers; amide polymers such as nylon 6, nylon 6,6, and aromatic polyamides; imide polymers; sulfone polymers; poly(ether sulfone) polymers; poly(ether ether ketone) polymers; poly(phenylene sulfide) polymers; poly(vinyl alcohol) polymers; polyoxymethylene polymers; and epoxy polymers. The base layer may also be formed from a blend of two or more resinous materials. The base layer preferably has smaller anisotropy in optical properties (e.g., phase difference). Particularly when the pressure-sensitive adhesive sheet is used as a surface-protecting film for an optical member, it is advantageous to allow the base layer to have smaller optical anisotropy. The base layer may have a single-layer structure, or a multilayer structure including two or more layers differing in composition from each other. The base layer particularly preferably has a single-layer structure.

Where necessary, the base layer may contain any of additives such as antioxidants, ultraviolet absorbers, antistatic components, plasticizers, and colorants (e.g., pigments and dyestuffs).

The first face (the surface on which a top coat layer is to be provided) of the base layer may have undergone a known or customary surface treatment such as corona discharge treatment, plasma treatment, ultraviolet irradiation, acid treatment, base treatment, or primer coating. The surface treatment may be performed, for example, to increase the adhesion between the base layer and the top coat layer. Among them, preferably employed is such a surface treatment as to introduce a polar group such as hydroxyl group (—OH group) into the first face of the base layer.

The second face (generally the surface on which an acrylic pressure-sensitive adhesive layer is to be formed) of the base layer may also have undergone any of surface treatments as above. These surface treatment may be performed to increase the adhesion between the transparent film substrate and the acrylic pressure-sensitive adhesive layer (to increase the anchoring capability of the acrylic pressure-sensitive adhesive layer).

The base layer may have any thickness suitably selectable according to the intended use and purpose, but has a thickness of preferably from 10 to 200 μm, more preferably from 15 to 100 μm, and furthermore preferably from 20 to 70 μm. This range is preferred for good balance typically of strength and workability (e.g., handleability) with other conditions or properties such as cost and facilitation of visual inspection.

The base layer may have a refractive index not critical, but preferably from 1.43 to 1.6 and more preferably from 1.45 to 1.5 from the viewpoint of visual quality.

The base layer may have a total luminous transmittance in the visible light region not critical, but preferably from 80% to 97% and more preferably from 85% to 95% from the viewpoint of visual quality. The total light transmittance herein is measured according to JIS K7361-1.

The base layer may have an arithmetic mean surface roughness (Ra) not critical, but has an arithmetic mean surface roughness on the second face of typically preferably from 0.001 to 1 μm and more preferably from 0.01 to 0.7 μm. The second face herein is generally the surface on which an acrylic pressure-sensitive adhesive layer is to be formed. The base layer, if having an arithmetic mean surface roughness of more than 1 μm on the second face, may cause poor thickness accuracy of the coated face (adhesive face) of the acrylic pressure-sensitive adhesive layer. The base layer in this case may also cause insufficient anchoring capability of the acrylic pressure-sensitive adhesive layer with respect to the transparent film substrate, because the pressure-sensitive adhesive fails to migrate into space inside surface asperities of the transparent film substrate, resulting in a smaller contact area between the acrylic pressure-sensitive adhesive layer and the transparent film substrate. These are because the acrylic pressure-sensitive adhesive layer in the pressure-sensitive adhesive sheet according to the present invention has a high solvent-insoluble content in some embodiments. In contrast, the base layer, if having an arithmetic mean surface roughness of less than 0.001 μm, may become susceptible to blocking and/or have insufficient handleability, thus impeding industrial production.

Top Coat Layer

The top coat layer in the transparent film substrate of the pressure-sensitive adhesive sheet according to the present invention is a surface layer present at least on the first face of the base layer and is formed from at least a polythiophene, an acrylic resin, and a melamine crosslinking agent as essential components. The pressure-sensitive adhesive sheet according to the present invention, as having the top coat layer, can exhibit various functions including not only scratch resistance and antistatic properties, but also solvent resistance, printability, and ink adhesion. The pressure-sensitive adhesive sheet according to the present invention, when having the function(s), is particularly preferably used for optical film surface protection.

The acrylic resin in the top coat layer serves as a base component (base resin) contributing to the film formation of the top coat layer and contains an acrylic polymer as a base polymer. The term “base polymer” refers to a principal component among polymer components, i.e., a component present in an amount of 50 percent by weight or more of entire polymer components. Specifically, the acrylic resin may contain the acrylic polymer in a content of 50 percent by weight or more (e.g., from 50 to 100 percent by weight), preferably from 70 to 100 percent by weight, and more preferably from 90 to 100 percent by weight, of the total amount (100 percent by weight) of the acrylic resin.

The term “acrylic polymer” as used herein refers to a polymer that contains, as a main monomer component, a monomer having at least one (meth)acryloyl group per molecule (in molecule). This monomer is also referred to as an “acrylic monomer.” Specifically, monomer components constituting the acrylic polymer contain at least one acrylic monomer in a content of 50 percent by weight or more based on the total amount (100 percent by weight) of the entire monomer components. As used herein the term “(meth)acryloyl group” refers to acryloyl group and/or methacryloyl group (one or both of acryloyl group and methacryloyl group).

The acrylic resin usable herein is exemplified by, but not limited to, acrylic resins of various types, such as thermosetting acrylic resins, ultraviolet-curable acrylic resins, electron-beam-curable acrylic resins, and two-part acrylic resins. Each of different acrylic resins may be used alone or in combination. Among them, preferably selected is an acrylic resin capable of forming a top coat layer that is highly resistant to scratches (e.g., is evaluated as good in scratch resistance evaluation in after-mentioned “Evaluations”) and transmits light satisfactorily. The acrylic resin in the top coat layer can be grasped also as a binder (binder resin) for the polythiophene (antistatic component).

The acrylic polymer serving as a base polymer of the acrylic resin is preferably, but not limited to, an acrylic polymer containing methyl methacrylate (MMA) as a principal monomer component (monomeric component) and is more preferably a copolymer of methyl methacrylate with one or more other monomers. As the other monomers, acrylic monomers other than methyl methacrylate are preferred. Methyl methacrylate may be copolymerized to form the acrylic polymer in an amount not critical, but preferably 50 percent by weight or more (e.g., from 50 to 90 percent by weight) and more preferably 60 percent by weight or more (e.g., from 60 to 85 percent by weight) based on the total amount (100 percent by weight) of entire monomer components constituting the acrylic polymer.

The monomers to be copolymerized with methyl methacrylate to form the acrylic polymer are exemplified by, but not limited to, (meth)acrylic alkyl esters other than methyl methacrylate, of which preferably exemplified are (meth)acrylic alkyl esters having a straight or branched chain alkyl group; and (meth)acrylic alkyl esters (cycloalkyl(meth)acrylates) having an alicyclic alkyl group (cycloalkyl group).

The (meth)acrylic alkyl esters having a straight or branched chain alkyl group are exemplified by, but not limited, alkyl acrylates (acrylic alkyl esters) whose alkyl moiety having 1 to 12 carbon atoms, such as methyl acrylate, ethyl acrylate, n-butyl acrylate (BA), and 2-ethylhexyl acrylate (2EHA); and alkyl methacrylates (methacrylic alkyl esters) whose alkyl moiety having 2 to 6 carbon atoms, such as ethyl methacrylate, isopropyl methacrylate, n-butyl methacrylate, and isobutyl methacrylate. The (meth)acrylic alkyl esters having an alicyclic alkyl group are exemplified by, but not limited to, cycloalkyl acrylates whose cycloalkyl moiety having 5 to 7 carbon atoms, such as cyclopentyl acrylate and cyclohexyl acrylate; and cycloalkyl methacrylates whose cycloalkyl moiety having 5 to 7 carbon atoms, such as cyclopentyl methacrylate and cyclohexyl methacrylate (CHMA).

In an exemplary preferred embodiment, the acrylic polymer is one derived from monomer components including at least methyl methacrylate (MMA) and cyclohexyl methacrylate (CHMA). In this embodiment, cyclohexyl methacrylate may be copolymerized in a percentage not critical, but typically preferably 25 percent by weight or less (e.g., from 0.1 to 25 percent by weight) and more preferably 15 percent by weight or less (e.g., from 0.1 to 15 percent by weight) based on the total amount (100 percent by weight) of entire monomer components constituting the acrylic polymer.

In another exemplary preferred embodiment, the acrylic polymer is one derived from monomer components including at least methyl methacrylate (MMA) and at least one of n-butyl acrylate (BA) and 2-ethylhexyl acrylate (2EHA). In this embodiment, n-butyl acrylate and 2-ethylhexyl acrylate may be copolymerized in a percentage (in a total percentage when the two monomers are copolymerized) not critical, but typically preferably 40 percent by weight or less (e.g., from 1 to 40 percent by weight), more preferably from 10 to 40 percent by weight, furthermore preferably 30 percent by weight or less (e.g., from 3 to 30 percent by weight), and particularly preferably from 15 to 30 percent by weight, based on the total amount (100 percent by weight) of entire monomer components constituting the acrylic polymer.

In a particularly preferred embodiment, the acrylic polymer is one derived from monomer components substantially including methyl methacrylate, cyclohexyl methacrylate, and at least one of n-butyl acrylate and 2-ethylhexyl acrylate. Specifically, preferred is an acrylic polymer derived from monomer components having a total sum of contents (total content) of methyl methacrylate, cyclohexyl methacrylate, n-butyl acrylate, and 2-ethylhexyl acrylate of 52 percent by weight or more, based on the total amount (100 percent by weight) of entire monomer components constituting the acrylic polymer.

The acrylic polymer may be derived from monomer components further including one or more monomers (other monomers) other than the above-mentioned monomers, within ranges not significantly adversely affecting advantageous effects of the present invention. The other monomers are exemplified by carboxyl-containing monomers such as acrylic acid, methacrylic acid, itaconic acid, maleic acid, and fumaric acid; acid-anhydride-containing monomers such as maleic anhydride and itaconic anhydride; vinyl esters such as vinyl acetate and vinyl propionate; aromatic vinyl compounds such as styrene and α-methylstyrene; amido-containing monomers such as acrylamide and N,N-dimethylacrylamide; amino-containing monomers such as aminoethyl(meth)acrylate and N,N-dimethylaminoethyl(meth)acrylate; imido-containing monomers such as cyclohexylmaleimide; epoxy-containing monomers such as glycidyl(meth)acrylate; (meth)acryloylmorpholine; vinyl ethers such as methyl vinyl ether; and hydroxyl-containing monomers such as hydroxyethyl(meth)acrylate, hydroxypropyl (meth)acrylate, hydroxybutyl(meth)acrylate, hydroxypentyl(meth)acrylate, hydroxyhexyl(meth)acrylate, hydroxyoctyl(meth)acrylate, hydroxydecyl(meth)acrylate, hydroxylauryl(meth)acrylate, (4-hydroxymethylcyclohexyl)methyl acrylate, N-methylol(meth)acrylamide, vinyl alcohol, allyl alcohol, hydroxyethyl vinyl ether, hydroxybutyl vinyl ether, and diethylene glycol monovinyl ether. Such “other monomer(s)” may be copolymerized in a percentage (in a total percentage when two or more different monomers are used) not critical, but preferably 20 percent by weight or less, more preferably 10 percent by weight or less, furthermore preferably 5 percent by weight or less, and most preferably 3 percent by weight or less. The monomer components to form the acrylic polymer may include substantially no “other monomers” to be copolymerized. Typically, the acrylic polymer may have a content of other monomers of 0.1 percent by weight or less based on the total amount (100 percent by weight) of entire monomers constituting the acrylic polymer.

The acrylic polymer is preferably derived from copolymerization components including substantially no acidic-functional-group-containing monomer (e.g., acrylic acid and methacrylic acid). Specifically, the acrylic polymer preferably has a content of an acidic-functional-group-containing monomer of 0.1 percent by weight or less based on the total amount of entire monomer components constituting the acrylic polymer. The top coat layer, when employing a melamine crosslinking agent in combination with the acrylic polymer including substantially no acidic-functional-group-containing monomer as constituents, can readily have a higher hardness and exhibit higher adhesion to the base layer. As used herein the term “acidic functional group” refers to a functional group capable of becoming acidic, such as carboxyl group and acid anhydride group. This is also true for the following description.

The acrylic polymer is preferably derived from copolymerization components including a monomer having a hydroxyl group (hydroxyl-containing monomer). The hydroxyl-containing monomer, when copolymerized, helps the top coat layer to have better adhesion to the base layer.

The acrylic resin to form the top coat layer may further include one or more other resin components (except polythiophenes) in addition to the acrylic polymer. The acrylic resin should have a content of the other resin component(s) of less than 50 percent by weight based on the total amount (100 percent by weight) of the acrylic resin.

The polythiophene in the top coat layer is a component (antistatic component) having the function of preventing static electrification of the pressure-sensitive adhesive sheet according to the present invention. The pressure-sensitive adhesive sheet according to the present invention, as including the polythiophene in the top coat layer, exhibits satisfactory antistatic properties and particularly preferably usable as a surface-protecting film for use typically in working or transportation process of static-sensitive articles such as liquid crystal cells and semiconductor devices.

In addition, the polythiophene is highly hydrophobic, less absorbs moisture in a high-humidity environment (under humid conditions), and thereby less causes clouding of the transparent film substrate (more specifically, hygroscopic clouding of the top coat layer). In contrast, a hygroscopic substance (e.g., an ammonium salt), if employed as an antistatic component of the top coat layer, may often cause clouding of the substrate in a high-humidity environment (more specifically, hygroscopic clouding of the top coat layer).

Examples of the polythiophene include polymers of unsubstituted thiophene; and polymers of substituted thiophenes such as 3,4-ethylenedioxythiophene. Among them, the polythiophene is preferably a polymer of 3,4-ethylenedioxythiophene, i.e., a poly(3,4-ethylenedioxythiophene), from the viewpoint of antistatic properties.

Though not critical, the polythiophene has a weight-average molecular weight (Mw) of preferably 40×10⁴ or less (e.g., from 0.1×10⁴ to 40×10⁴) and more preferably from 0.5×10⁴ to 30×10⁴ in terms of a polystyrene standard. The polythiophene, if having a weight-average molecular weight Mw of more than 40×10⁴, may suffer from insufficient compatibility to cause the pressure-sensitive adhesive sheet to have poor visual quality and/or insufficient solvent resistance in some combinations with other components constituting the top coat layer. In contrast, the polythiophene, if having a weight-average molecular weight Mw of less than 0.1×10⁴, may cause poor scratch resistance.

The polythiophene may be used in an amount (content in the top coat layer) not critical, but preferably from 10 to 200 parts by weight, more preferably from 25 to 150 parts by weight, and furthermore preferably from 40 to 120 parts by weight, per 100 parts by weight of the acrylic polymer in the top coat layer. The polythiophene, if used in an amount of less than 10 parts by weight, may cause the top coat layer surface of the transparent film substrate to have an excessively high surface resistivity that is difficult to be controlled within a range mentioned later. In contrast, the polythiophene, if used in an amount of more than 200 parts by weight, may often cause the top coat layer to have a large thickness variation ΔD and thereby cause the pressure-sensitive adhesive sheet to appear partially cloudy and to have inferior visual quality. In this case, the polythiophene may suffer from insufficient compatibility to cause the pressure-sensitive adhesive sheet to have poor visual quality and/or insufficient solvent resistance in some combinations with other components constituting the top coat layer.

In an embodiment as mentioned later, the top coat layer may be formed by a process of applying a liquid composition (a top coat layer coating composition) onto the base layer surface and drying or curing the applied composition. In this embodiment, the polythiophene to prepare the composition is preferably used as a solution or dispersion of the polythiophene in water (an aqueous polythiophene solution or dispersion). The aqueous polythiophene solution or dispersion may be prepared typically by dissolving or dispersing a polythiophene having a hydrophilic functional group in water. The polythiophene of this type can be synthetically prepared typically by a technique of copolymerizing a monomer having a hydrophilic functional group in molecule. The hydrophilic functional group is exemplified by sulfo group, amino group, amido group, imino group, hydroxyl group, mercapto group, hydrazino group, carboxyl group, quaternary ammonium group, sulfuric ester group (—O—SO₃H), and phosphoric ester groups (e.g., —O—PO (OH)₂). These hydrophilic functional groups may each form a salt. The aqueous polythiophene solution may also be a commercial product available under the trade names of “Denatron” series (from Nagase ChemteX Corporation).

Of such aqueous polythiophene solutions, an aqueous polythiophene solution including a polystyrenesulfonate (PSS) is particularly preferred for stable antistatic properties. In the aqueous PSS-including polythiophene solution, the PSS can be present as a dopant doped to a polythiophene. The aqueous PSS-including polythiophene solution may have a ratio of the polythiophene to the polystyrenesulfonate [polythiophene:polystyrenesulfonate] not critical, but preferably from 1:5 to 1:10. The aqueous PSS-including polythiophene solution may contain the polythiophene and the polystyrenesulfonate in a total sum of contents (total content) not critical, but preferably from 1 to 5 percent by weight. The aqueous PSS-including polythiophene solution can also be a commercial product available typically under the trade name of “Baytron” (from H.C. Stark GmbH). The aqueous PSS-including polythiophene solution, when used, may contain the polythiophene and the polystyrenesulfonate in a total amount not critical, but preferably from 10 to 200 parts by weight, more preferably from 25 to 150 parts by weight, and furthermore preferably from 40 to 120 parts by weight, per 100 parts by weight of the acrylic polymer in the top coat layer.

The top coat layer, as employing the acrylic resin as a base resin in combination with the polythiophene as an antistatic component, can give a transparent film substrate having a low surface resistivity even when the top coat layer has a small thickness. A further better result is obtained particularly when employing, as the acrylic resin, an acrylic resin mainly including an acrylic polymer derived from copolymerization components including substantially no acidic-functional-group-containing monomer.

The melamine crosslinking agent in the top coat layer plays a role of crosslinking the acrylic polymer to exhibit at least one advantageous effect including better scratch resistance, better solvent resistance, better ink adhesion, and lower frictional coefficient (of which better scratch resistance is preferred). The term “melamine crosslinking agent” refers to a compound having a melamine structure. The melamine crosslinking agent is exemplified by methylolmelamines such as monomethylolmelamine, dimethylolmelamine, trimethylolmelamine, tetramethylolmelamine, pentamethylolmelamine, and hexamethylolmelamine; alkoxyalkylmelamines including alkoxymethylmelamines such as methoxymethylmelamine, ethoxymethylmelamine, propoxymethylmelamine, butoxymethylmelamine, hexa(methoxymethyl)melamine, hexa(ethoxymethyl)melamine, hexa(propoxymethyl)melamine, hexa(butoxymethyl)melamine, hexa(pentyloxymethyl)melamine, and hexa(hexyloxymethyl)melamine, as well as alkoxybutylmelamines such as methoxybutylmelamine, ethoxybutylmelamine, propoxybutylmelamine, and butoxybutylmelamine.

The melamine crosslinking agent can also be any of commercial products available typically under the trade names of “CYMEL202”, “CYMEL212”, “CYMEL232”, “CYMEL235”, “CYMEL253”, “CYMEL266”, “CYMEL267”, “CYMEL270”, “CYMEL272”, “CYMEL285”, “CYMEL300”, “CYMEL301”, “CYMEL303”, “CYMEL327”, “CYMEL350”, “CYMEL370”, “CYMEL701”, “CYMEL703”, and “CYMEL771” (each from Cytec Industries Inc.); and under the trade names of “NIKALAC MW-30”, “NIKALAC MW-30M”, “NIKALAC MW-30HM”, “NIKALAC MW-45”, “NIKALAC MW-390”, “NIKALAC MX-270”, “NIKALAC MX-302”, “NIKALAC MX-706”, and “NIKALAC MX-750” (each from Sanwa Chemical Co., Ltd.).

The melamine crosslinking agent may be used in an amount (a content in the top coat layer coating composition) not critical, but preferably from 5 to 100 parts by weight, more preferably from 10 to 80 parts by weight, and furthermore preferably from 20 to 50 parts by weight, per 100 parts by weight of the acrylic polymer in the top coat layer. The melamine crosslinking agent, if used in an amount of less than 5 parts by weight, may cause insufficient scratch resistance. In contrast, the melamine crosslinking agent, if used in an amount of more than 100 parts by weight, may cause insufficient printability. In this case, the melamine crosslinking agent may also suffer from insufficient compatibility to cause poor visual quality and/or insufficient solvent resistance in some combinations with other components constituting the top coat layer.

The top coat layer, when employing the melamine crosslinking agent in combination with the acrylic polymer including substantially no acidic-functional-group-containing monomer, may readily have higher hardness and better adhesion to the base layer, as described above.

The top coat layer preferably contains a lubricant (slip additive) so as to allow the pressure-sensitive adhesive sheet according to the present invention to exhibit better scratch resistance. The lubricant can be any of known or customary lubricants, of which fluorochemical lubricants and silicone lubricants are preferably employed. Among them, silicone lubricants (silicone-based lubricants) are preferred. The silicone lubricants are exemplified by polydimethylsiloxanes, polyether-modified polydimethylsiloxanes, and polymethylalkylsiloxanes. Examples of the lubricant for use herein also include lubricants containing a fluorochemical compound or silicone compound having an aryl group and/or an aralkyl group. These are also called “printable lubricants” because they particularly improve the printability. Examples of the lubricant further include lubricants (reactive lubricants) containing a fluorochemical compound or silicone compound having a crosslinkable reactive group.

The lubricant may be used in an amount not critical, but preferably from 5 to 90 parts by weight, more preferably from 10 to 70 parts by weight, furthermore preferably 15 parts by weight or more (e.g., from 15 to 50 parts by weight), particularly preferably 20 parts by weight or more, and most preferably 25 parts by weight or more, per 100 parts by weight of the acrylic polymer in the top coat layer. The lubricant, if used in an amount of less than 5 parts by weight, may cause insufficient scratch resistance. In contrast, the lubricant, if used in an amount of more than 90 parts by weight, may cause insufficient printability and/or may cause the top coat layer (consequently, the transparent film substrate, and the pressure-sensitive adhesive sheet) to have poor visual quality.

The lubricant reduces the frictional coefficient probably by bleeding out to the top coat layer surface and imparting the lubricity to the surface. Suitable use of the lubricant therefore contributes to better scratch resistance through reduction in frictional coefficient. The lubricant can uniformize the surface tension of the top coat layer coating composition and can also contribute to better uniformity in thickness and less interference fringe of the top coat layer (and consequently to better visual quality). Such better visual quality is significant particularly in the surface-protecting film for an optical member. In an embodiment, the acrylic resin constituting the top coat layer is an ultraviolet-curable acrylic resin. In this embodiment, a fluorochemical or silicone lubricant is preferably added to the top coat layer coating composition. When the composition is applied to the base layer and dried, the lubricant bleeds out at the coating surface (interface with the atmosphere), and this suppresses curing inhibition by oxygen during ultraviolet irradiation and allows the ultraviolet-curable acrylic resin to be sufficiently cured even in an outermost surface of the top coat layer.

Where necessary, the top coat layer may further include one or more additives within ranges not adversely affecting advantageous effects of the present invention. The additives are exemplified by antistatic components other than polythiophenes, antioxidants, colorants (e.g., pigments and dyestuffs), viscosity-adjusting agents (e.g., thixotropic agents and thickeners), film-forming aids, and catalysts (e.g., ultraviolet-induced polymerization initiators for use in compositions containing an ultraviolet-curable acrylic resin).

The antistatic components other than polythiophenes can be any of known or customary antistatic components without limitation, but are exemplified by organic or inorganic electroconductive materials and various antistatic agents.

The organic electroconductive materials are exemplified by, but not limited to, electroconductive polymers other than polythiophenes, such as polyanilines, polypyrroles, polyethyleneimines, and allylamine polymers. Each of different electroconductive polymers may be used alone or in combination. They may also be used in combination with any of other antistatic components (inorganic electroconductive materials and antistatic agents).

The polyanilines are also available as commercial products typically under the trade name of “aqua-PASS” (from Mitsubishi Rayon Co., Ltd., an aqueous poly(anilinesulfonic acid) solution).

The inorganic electroconductive materials are exemplified by, but not limited to, tin oxide, antimony oxide, indium oxide, cadmium oxide, titanium oxide, zinc oxide, indium, tin, antimony, gold, silver, copper, aluminum, nickel, chromium, titanium, iron, cobalt, copper iodide, ITO (indium oxide/tin oxide), and ATO (antimony oxide/tin oxide).

The top coat layer in the transparent film substrate of the pressure-sensitive adhesive sheet according to the present invention may be formed by any process without limitation, such as a process of preparing a liquid composition (top coat layer coating composition) by dispersing or dissolving the acrylic resin, polythiophene, melamine crosslinking agent, and optional additives in a suitable solvent or medium, and applying the liquid composition to the base layer surface. More specifically, preferably employed is a process of applying the liquid composition to the base layer surface, drying the applied composition, and according to necessity, performing a curing treatment (e.g., a heat treatment or ultraviolet irradiation) to form the top coat layer.

The liquid composition (top coat layer coating composition) may have a solids content (NV; nonvolatile content) not critical, but preferably 5 percent by weight or less (e.g., from 0.05 to 5 percent by weight), more preferably 1 percent by weight or less (e.g., from 0.1 to 1 percent by weight), and furthermore preferably 0.5 percent by weight or less, and particularly preferably 0.3 percent by weight or less. The liquid composition, if having a solids content of more than 5 percent by weight, may have an excessively high viscosity and often suffer from unevenness in drying time from a region to another, and these may impede the formation of a top coat layer that is thin and uniform (i.e., with a small thickness variation ΔD). A lower limit of the solids content of the liquid composition is not critical, but is preferably 0.05 percent by weight and more preferably 0.1 percent by weight. The liquid composition, if having a solids content of less than 0.05 percent by weight, may give a coat (top coat layer) readily suffering from crawling and thereby having a larger thickness variation ΔD in some materials and surface quality of the base layer.

The solvent constituting the liquid composition (top coat layer coating composition) is preferably one that can stably dissolve or disperse therein the constituents (e.g., the acrylic resin, polythiophene, and melamine crosslinking agent) to form a top coat layer. The solvent usable herein is exemplified by an organic solvent, water, and a mixture of them. The organic solvent can be any one selected typically from esters such as ethyl acetate; ketones such as methyl ethyl ketone, acetone, and cyclohexanone; cyclic ethers such as tetrahydrofuran (THF) and dioxane; aromatic hydrocarbons such as toluene and xylenes; aliphatic or alicyclic alcohols such as methanol, ethanol, n-propanol, isopropyl alcohol, and cyclohexanol; and glycol ethers. Each of different organic solvents may be used alone or in combination. Among them, solvents containing a glycol ether as a principal component (e.g., solvents containing a glycol ethers in a content of 50 percent by weight or more) are preferred for stable coating formation.

The glycol ether for use herein is preferably one or more glycol ethers selected from the group consisting of alkylene glycol monoalkyl ethers and dialkylene glycol monoalkyl ethers. Specifically, these glycol ethers are exemplified by ethylene glycol monomethyl ether, ethylene glycol monoethyl ether, ethylene glycol monopropyl ether, ethylene glycol monobutyl ether, propylene glycol monomethyl ether, propylene glycol monopropyl ether, diethylene glycol monomethyl ether, diethylene glycol monoethyl ether, diethylene glycol monopropyl ether, diethylene glycol monobutyl ether, and diethylene glycol-mono-2-ethylhexyl ether.

The top coat layer has an average thickness Dₐᵥₑ of from 2 to 50 nm, preferably from 2 to 30 nm, more preferably from 2 to 20 nm, and furthermore preferably from 2 to 10 nm. The top coat layer, if having an average thickness Dₐᵥₑ of more than 50 nm, may cause transparent film substrate to appear wholly cloudy, and this may readily cause the transparent film substrate (consequently a pressure-sensitive adhesive sheet having the transparent film substrate) to have inferior visual quality. In contrast, the top coat layer, if having an average thickness Dₐᵥₑ of less than 2 nm, may be difficult to be formed uniformly.

The average thickness Dₐᵥₑ of the top coat layer can be determined by measuring thicknesses of the top coat layer at five different measurement points arranged at regular intervals along a straight line crossing the top coat layer (typically, a straight line crossing the top coat layer in the width direction), and calculating an arithmetic mean of the measured thicknesses at the five measurement points. In the measurement points, two adjacent measurement points are desirably positioned at a distance of 2 cm or longer (preferably 5 cm or longer) from each other.

The thickness of the top coat layer (thickness of the top coat layer at each measurement point) can be measured typically by observing a cross section of the transparent film substrate (or the pressure-sensitive adhesive sheet) with a transmission electron microscope (TEM). Specifically, the measurement may be performed typically by preparing a sample from the transparent film substrate (or the pressure-sensitive adhesive sheet), staining the sample with a heavy metal to make the top coat layer distinguishable, embedding the stained sample in a resin, slicing the embedded sample ultrathin for TEM analysis of a sample's cross section. The obtained data can be utilized as the thickness of the top coat layer. Typically, a transmission electron microscope Model “H-7650” supplied by Hitachi, Ltd. can be used as the TEM.

In Examples described later, the thickness (average thickness within the field of view) of the top coat layer was actually measured by obtaining a cross-sectional image at an accelerating voltage of 100 kV and a 60000-fold magnification, converting the image to a binary code, and dividing the cross-sectional area of the top coat layer by the sample length in the field of view.

The heavy-metal staining may be omitted when the top coat layer is sufficiently distinguishable even in observation without any heavy-metal staining.

Alternatively, the thickness of the top coat layer may be determined by calculation using a calibration curve prepared based on correlations between the thickness determined by TEM and values obtained by various other thickness measuring devices (e.g., surface profile gauges, interferometric thickness gauges, infrared spectrometers, and various X-ray diffractometers).

The top coat layer has a thickness variation ΔD of 40% or less (e.g., from 0% to 40%), preferably 30% or less, more preferably 25% or less, and furthermore preferably 20% or less.

The thickness variation ΔD of the top coat layer is determined by measuring thicknesses of the top coat layer at five different measurement points arranged at regular intervals along a straight line crossing the top coat layer (typically, a straight line crossing the top coat layer in the width direction); dividing the difference between the maximum thickness Dₘₐₓ and the minimum thickness Dₘᵢₙ by the average thickness Dₐᵥₑ; and defining the resulting value as the thickness variation [i.e., ΔD (%)=(Dₘₐₓ−Dₘᵢₙ)/Dₐᵥₑ×100]. Of the measurement points, two adjacent measurement points are desirably at a distance of 2 cm or longer (preferably 5 cm or longer) from each other. The thickness of the top coat layer at each measurement point can for example be directly measured by TEM observation or can be determined by determining a value with a suitable thickness gauge and converting the value to a thickness based on the calibration curve, as described above.

More specifically, the average thickness Dₐᵥₑ and the thickness variation ΔD of the top coat layer can be determined in accordance with the thickness measurement method outlined in Examples.

The top coat layer, as having a thickness variation ΔD of 40% or less, less appears streaky or uneven due to partial clouding and brings good visual quality. Specifically, a decreasing thickness variation ΔD can bring better visual quality. The top coat layer, when having a small thickness variation ΔD, also advantageously contributes to the formation of a transparent film substrate having a small average thickness Dₐᵥₑ and a low surface resistivity.

The top coat layer may have an X-ray intensity variation ΔI not critical, but preferably 40% or less (e.g., from 0% to 40%), more preferably 30% or less, furthermore preferably 25% or less, and particularly preferably 20% or less, as determined by X-ray fluorescence (XRF) analysis. The X-ray intensity variation ΔI may be determined by measuring X-ray intensities I through XRF analysis at five different measurement points arranged at regular intervals along a straight line crossing the top coat layer (typically, a straight line crossing the top coat layer in the width direction); dividing the difference between the maximum intensity Iₘₐₓ and the minimum intensity Iₘᵢₙ by the average X-ray intensity Iₐᵥₑ; and defining the resulting value as the X-ray intensity variation ΔI [i.e., ΔI (%)=(Iₘₐₓ−Iₘᵢₙ)/Iₐᵥₑ×100]. Of the measurement points, two adjacent measurement points are desirably at a distance of 2 cm or longer (preferably 5 cm or longer) from each other.

The “average X-ray intensity Iₐᵥₑ” refers to an arithmetic mean of X-ray intensities I at the five measurement points. The X-ray intensity is generally indicated in kcps (number (kilo counts) per second of X-ray photons entering through a receiving slit). Specifically, the average intensity Iₐᵥₑ and the intensity variation ΔI can be measured typically in accordance with the X-ray intensity variation measurement method outlined in Examples. The top coat layer, when having an intensity variation ΔI of 40% or less, less appears streaky or uneven due to partial clouding and can readily bring good visual quality. In general, the top coat layer tends to have a decreasing intensity variation ΔI with a decreasing thickness variation ΔD. The top coat layer, when having a small intensity variation ΔI, may therefore advantageously contribute to the formation of a transparent film substrate having a small average thickness Dₐᵥₑ and a low surface resistivity.

An element to be analyzed by the XRF analysis can be any of XRF-analyzable elements contained in the top coat layer. Of such atoms, preferably employed for the XRF analysis are sulfur atom (e.g., sulfur atom (S) derived from a polythiophene contained in the top coat layer), silicon atom (e.g., silicon atom (Si) derived from a silicone lubricant contained in the top coat layer), and tin atom (e.g., tin atom (Sn) derived from tin oxide particles contained as a filler in the top coat layer). In a preferred embodiment, the top coat layer has an X-ray intensity variation ΔI of 40% or less as determined by sulfur atom XRF analysis. In another preferred embodiment, the top coat layer has an X-ray intensity variation ΔI of 40% or less as determined by silicon atom XRF analysis.

The XRF analysis can be performed typically in the following manner. Specifically, a commercially available XRF analyzer is preferably employed. A dispersive crystal can be appropriately selected for use. Typically, a Ge crystal can be preferably used. The output settings and other conditions can be suitably selected in accordance with the used instrument. Usually, a sufficient resolution can be obtained with an output of about 70 mA at 50 kV. More specifically, the XRF analysis conditions outlined in Examples can be preferably employed.

In a preferred embodiment for higher measurement accuracy, an element preferred to be analyzed has an X-ray intensity per area corresponding to a 30 mm diameter circle of about 0.01 kcps or more (more preferably 0.03 kcps or more, typically from about 0.05 to about 3.00 kcps) under predetermined XRF analysis conditions.

The transparent film substrate in the pressure-sensitive adhesive sheet according to the present invention is a transparent substrate including the base layer; and the top coat layer present on or over at least the first face of the base layer. Specifically, the transparent film substrate may have a total luminous transmittance in the visible light region not critical, but preferably from 80% to 97% and more preferably from 85% to 95%, as determined according to JIS K7361-1. The transparent film substrate may have a haze not critical, but preferably from 1.0% to 5.0% and more preferably from 2.0% to 3.5%, as determined according to JIS K7136. The transparent film substrate, if having a total luminous transmittance and/or a haze out of the above-specified range, may readily impede the visual inspection of the adherend.

Though not critical, the transparent film substrate has a thickness of preferably from 10 to 150 μm and more preferably from 30 to 100 μm. The transparent film substrate, if having a thickness of less than 10 μm, may fail to sufficiently effectively contribute to the protection of the optical member from scratching. In contrast, the transparent film substrate, if having a thickness of more than 150 μm, may cause higher cost.

Acrylic Pressure-Sensitive Adhesive Layer

The acrylic pressure-sensitive adhesive layer in the pressure-sensitive adhesive sheet according to the present invention is formed from a water-dispersible acrylic pressure-sensitive adhesive composition containing an after-mentioned acrylic emulsion polymer as an essential component (water-dispersible removable acrylic pressure-sensitive adhesive composition). This composition is also referred to as a “pressure-sensitive adhesive composition for use in the present invention.” The pressure-sensitive adhesive composition for use in the present invention preferably further contains a water-insoluble crosslinking agent having two or more carboxyl-reactive functional groups in molecule (per molecule).

Acrylic Emulsion Polymer

The acrylic emulsion polymer in the pressure-sensitive adhesive composition for use in the present invention is a polymer (acrylic polymer) derived from a (meth)acrylic alkyl ester (A) and a carboxyl-containing unsaturated monomer (B) as essential constitutive monomers (constitutive monomer components). Specifically, the acrylic emulsion polymer is a polymer obtained from a monomer mixture containing a (meth)acrylic alkyl ester (A) and a carboxyl-containing unsaturated monomer (B) as essential components. Each of different acrylic emulsion polymers may be used alone or in combination. As used herein the term “(meth)acrylic” refers to “acrylic” and/or “methacrylic” (either one or both of “acrylic” and “methacrylic.”

Of such acrylic emulsion polymers, preferred is a polymer derived from a (meth)acrylic alkyl ester (A), a carboxyl-containing unsaturated monomer (B), and at least one monomer (C) selected from the group consisting of methyl methacrylate, vinyl acetate, and diethylacrylamide as essential constitutive monomers. This is preferred for reducing the visual defects (such as dimples) of the pressure-sensitive adhesive layer. Specifically, the acrylic emulsion polymer is preferably a polymer obtained from a monomer mixture containing a (meth)acrylic alkyl ester (A), a carboxyl-containing unsaturated monomer (B), and at least one monomer (C) selected from the group consisting of methyl methacrylate, vinyl acetate, and diethylacrylamide as essential components. Each of different acrylic emulsion polymers may be used alone or in combination. The term “at least one monomer (C) selected from the group consisting of methyl methacrylate, vinyl acetate, and diethylacrylamide” is also simply referred to as a “monomer (C).” When two or more different monomers selected from the group consisting of methyl methacrylate, vinyl acetate, and diethylacrylamide are contained in constitutive monomers constituting the acrylic emulsion polymer, all of them are monomers (C).

The (meth)acrylic alkyl ester (A) is used as a principal monomer component and has the function mainly of exhibiting basic properties as a pressure-sensitive adhesive (or as a pressure-sensitive adhesive layer), such as adhesiveness and removability (peelability). Of such (meth)acrylic alkyl esters, acrylic alkyl esters readily impart flexibility to a polymer constituting a pressure-sensitive adhesive layer and effectively allows the pressure-sensitive adhesive layer to develop adhesion and tackiness; whereas methacrylic alkyl esters readily impart hardness (rigidity) to a polymer constituting the pressure-sensitive adhesive layer and effectively allows the pressure-sensitive adhesive layer to have controlled removability. The (meth)acrylic alkyl ester (A) is exemplified by, but not limited to, (meth)acrylic alkyl esters each having a straight, branched chain, or cyclic alkyl group having 2 to 16 (more preferably 2 to 10, and furthermore preferably 4 to 8) carbon atoms. Methyl methacrylate is excluded from the (meth)acrylic alkyl ester (A).

Of acrylic alkyl esters, preferred are acrylic alkyl esters having an alkyl group with 2 to 14 (more preferably 4 to 9) carbon atoms, of which more preferred are acrylic alkyl esters having a straight or branched chain alkyl group, such as n-butyl acrylate, isobutyl acrylate, s-butyl acrylate, isoamyl acrylate, hexyl acrylate, heptyl acrylate, octyl acrylate, 2-ethylhexyl acrylate, isooctyl acrylate, nonyl acrylate, and isononyl acrylate. Among them, 2-ethylhexyl acrylate is particularly preferred.

Of methacrylic alkyl esters, preferred are methacrylic alkyl esters having an alkyl group with 2 to 16 (more preferably 2 to 10) carbon atoms, which are exemplified by methacrylic alkyl esters having a straight or branched chain alkyl group, such as ethyl methacrylate, propyl methacrylate, isopropyl methacrylate, n-butyl methacrylate, isobutyl methacrylate, s-butyl methacrylate, and t-butyl methacrylate; and alicyclic methacrylic alkyl esters such as cyclohexyl methacrylate, bornyl methacrylate, and isobornyl methacrylate.

The (meth)acrylic alkyl ester (A) can be suitably selected according typically to the target adhesiveness, and each of different (meth)acrylic alkyl esters may be used alone or in combination.

The (meth)acrylic alkyl ester (A) may be contained in a content of from 70 to 99.5 percent by weight, preferably from 70 to 99 percent by weight, more preferably from 85 to 98 percent by weight, and furthermore preferably from 87 to 96 percent by weight, based on the total amount (100 percent by weight) of constitutive monomers (entire constitutive monomers) constituting the acrylic emulsion polymer. The (meth)acrylic alkyl ester (A), when contained in a content of 70 percent by weight or more, advantageously helps the pressure-sensitive adhesive layer to have better adhesiveness and better removability. In contrast, the (meth)acrylic alkyl ester (A), if contained in a content of more than 99.5 percent by weight, may cause the pressure-sensitive adhesive composition to give a pressure-sensitive adhesive layer having a visual defect, because of relatively low contents of the carboxyl-containing unsaturated monomer (B) and the monomer (C). When two or more different (meth)acrylic alkyl esters (A) are used as the (meth)acrylic alkyl ester (A), the total amount of all the (meth)acrylic alkyl esters may fall within the above-specified range.

The carboxyl-containing unsaturated monomer (B) can effectively exhibit the function of forming a protective layer on emulsion particles formed by the acrylic emulsion polymer and thereby protecting the particles from shear fracture. This function is further improved by neutralizing carboxyl group with a base. The stability of the particles against shear fracture is more generally referred to as mechanical stability. The carboxyl-containing unsaturated monomer (B), when used in combination with at least one water-insoluble crosslinking agent reactive with carboxyl group, can also act as crosslinking points during the formation of a pressure-sensitive adhesive layer through water removal. In addition, the carboxyl-containing unsaturated monomer (B) may increase the adhesion (anchoring capability) to the substrate through the water-insoluble crosslinking agent. The carboxyl-containing unsaturated monomer (B) as above is exemplified by (meth)acrylic acid (acrylic acid and methacrylic acid), itaconic acid, maleic acid, fumaric acid, crotonic acid, carboxyethyl acrylate, and carboxypentyl acrylate. As used herein the term “carboxyl-containing unsaturated monomer (B)” also includes acid anhydride-containing unsaturated monomers such as maleic anhydride and itaconic anhydride. Among them, acrylic acid is preferred because of being liable to have a high relative concentration in the surface of the particles and to thereby form a denser protective layer. Each of different carboxyl-containing unsaturated monomers may be used alone or in combination as the carboxyl-containing unsaturated monomer (B).

The carboxyl-containing unsaturated monomer (B) is contained in a content of from 0.5 to 10 percent by weight, preferably from 1 to 5 percent by weight, and more preferably from 2 to 4 percent by weight, based on the total amount (100 percent by weight) of constitutive monomers (entire constitutive monomers) constituting the acrylic emulsion polymer. The carboxyl-containing unsaturated monomer (B), when contained in a content of 10 percent by weight or less, helps the formed pressure-sensitive adhesive layer to less suffer from increase in interaction with the functional group on the adherend (e.g., polarizing plate) surface and to less suffer from increase in adhesive strength with time. Thus, the pressure-sensitive adhesive layer can advantageously exhibit better removability (peelability). The carboxyl-containing unsaturated monomer (B), if contained in a content of more than 10 percent by weight, may be polymerized in water to cause thickening (viscosity increase) because such a carboxyl-containing unsaturated monomer (B) (e.g., acrylic acid) is generally soluble in water. In contrast, the carboxyl-containing unsaturated monomer (B), when contained in a content of 0.5 percent by weight or more, may advantageously help the emulsion particles to have better mechanical stability. The carboxyl-containing unsaturated monomer (B) in this case may also advantageously help the pressure-sensitive adhesive layer to have better adhesion (anchoring capability) to the substrate, thus less causing adhesive residue.

The monomer(s) (C) (methyl methacrylate, vinyl acetate, and diethylacrylamide) mainly has the function of helping the pressure-sensitive adhesive layer to less suffer from visual defects (such as dimples). The monomer(s) (C) helps emulsion particles to have better stability and to be less gelatinized (aggregated) because the monomers are incorporated into the emulsion particles as being polymerized with another monomer during polymerization to form a polymerized product that forms the emulsion particles. The monomer(s) (C) also helps the emulsion particles to have better affinity for the hydrophobic, water-insoluble crosslinking agent to thereby exhibit better dispersibility. Thus, the pressure-sensitive adhesive sheet less suffers from dimples due to insufficient dispersion.

The monomer (C) may be contained in a content not critical, but preferably from 0.5 to 10 percent by weight, more preferably from 1 to 6 percent by weight, and furthermore preferably from 2 to 5 percent by weight, based on the total amount (100 percent by weight) of constitutive monomers (entire constitutive monomers) constituting the acrylic emulsion polymer. The monomer (C), when contained in a content of 0.5 percent by weight or more, may advantageously sufficiently exhibit its effect (suppression of visual defects). In contrast, the monomer (C), when contained in a content of 10 percent by weight or less, may give a relatively flexible polymer to form a pressure-sensitive adhesive layer and may bring better adhesion to the adherend. When two or more different monomers selected from the group consisting of methyl methacrylate, vinyl acetate, and diethylacrylamide are contained in the entire constitutive monomers constituting the acrylic emulsion polymer, the total of contents (total content) of methyl methacrylate, vinyl acetate, and diethylacrylamide corresponds to the “content of the monomer (C).”

Constitutive monomers constituting the acrylic emulsion polymer may further include one or more other monomer components to impart a specific function, in combination with the monomer components [the (meth)acrylic alkyl ester (A), the carboxyl-containing unsaturated monomer (B), and the monomer (C)]. Typically, for better crosslinking in the emulsion particles and higher cohesive force, there may be added (used) any of epoxy-containing monomers such as glycidyl(meth)acrylate; and multifunctional monomers such as trimethylolpropane tri(meth)acrylate and divinylbenzene. These may be added in an amount per each category of less than 5 percent by weight. The term “amount” to be added (to be used) herein refers to a content based on the total amount (100 percent by weight) of constitutive monomers (entire constitutive monomers) constituting the acrylic emulsion polymer.

Hydroxyl-containing unsaturated monomers such as 2-hydroxyethyl acrylate and 2-hydroxypropyl acrylate, when used as the other monomer components, are preferably added (used) in a smaller amount from the viewpoint of reducing clouding as stain. Specifically, the constitutive monomers may contain such a hydroxyl-containing unsaturated monomer in an amount (content) of preferably less than 1 percent by weight, more preferably less than 0.1 percent by weight, and furthermore preferably substantially zero (e.g., less than 0.05 percent by weight), based on the total amount (100 percent by weight) of constitutive monomers (entire constitutive monomers) constituting the acrylic emulsion polymer. However, such a hydroxyl-containing unsaturated monomer may be added (used) in an amount of from about 0.01 to about 10 percent by weight when used to introduce crosslinking points typically of crosslinking between hydroxyl group and isocyanate group, or metal crosslinking.

The acrylic emulsion polymer may be obtained by subjecting the constitutive monomers (monomer mixture) to emulsion polymerization with an emulsifier and a polymerization initiator.

The emulsifier for use in emulsion polymerization to form the acrylic emulsion polymer may be a reactive emulsifier including a radically polymerizable functional group introduced into molecule (reactive emulsifier containing a radically polymerizable functional group). Specifically, the acrylic emulsion polymer may be an acrylic emulsion polymer as polymerized using a reactive emulsifier containing a radically polymerizable functional group in molecule. Each of different reactive emulsifiers containing a radically polymerizable functional group may be used alone or in combination.

The reactive emulsifier containing a radically polymerizable functional group (hereinafter also referred to as “reactive emulsifier”) is an emulsifier containing at least one radically polymerizable functional group in molecule (per molecule). Examples of the reactive emulsifier include, but not limited to, various reactive emulsifiers having at least one radically polymerizable functional group such as vinyl group, propenyl group, isopropenyl group, vinyl ether group (vinyloxy group), and allyl ether group (allyloxy group). Each of different reactive emulsifiers may be used alone or in combination. The reactive emulsifier, when used, is incorporated into the polymer, and this advantageously reduces staining derived from the emulsifier. In addition, the reactive emulsifier helps the pressure-sensitive adhesive composition for use in the present invention to form an acrylic pressure-sensitive adhesive layer that is resistant to clouding during storage under humid conditions (hygroscopic clouding). The resulting pressure-sensitive adhesive sheet is particularly advantageously used in surface protection of optical members such as optical films.

The reactive emulsifier is exemplified by reactive emulsifiers each having (or corresponding to) a structure of a nonionic-anionic emulsifier (anionic emulsifier having a nonionic hydrophilic group), except with an introduced radically polymerizable functional group (radically reactive group) such as propenyl group or allyl ether group. Exemplary nonionic-anionic emulsifiers include sodium polyoxyethylene alkyl ether sulfates, ammonium polyoxyethylene alkyl phenyl ether sulfates, sodium polyoxyethylene alkyl phenyl ether sulfates, and sodium polyoxyethylene alkyl sulfosuccinates. Hereinafter a reactive emulsifier containing a structure corresponding to an anionic emulsifier, except with a radically polymerizable functional group being introduced, is referred to as an “anionic reactive emulsifier”; whereas a reactive emulsifier containing a structure corresponding to a nonionic-anionic emulsifier, except with a radically polymerizable functional group being introduced, is referred to as a “nonionic-anionic reactive emulsifier.”

Of reactive emulsifiers, anionic reactive emulsifiers are preferred, of which nonionic-anionic reactive emulsifiers are more preferred because these emulsifiers will be incorporated into the polymer to further less cause stains. Particularly when the water-insoluble crosslinking agent is an epoxy-containing multifunctional epoxy crosslinking agent, these reactive emulsifiers, as having catalytic activity, can help the crosslinking agent to exhibit higher reactivity. If no anionic reactive emulsifier is used, the crosslinking reaction may not complete even through aging, and this may cause the pressure-sensitive adhesive layer to have an adhesive strength varying with time. The anionic reactive emulsifiers are also preferred because they are incorporated into the polymer, thereby do not precipitate to the adherend surface, and do not cause clouding as stain, unlike quaternary ammonium compounds (e.g., see JP-A No. 2007-31585), which are generally used as catalysts for epoxy crosslinking agents and precipitate to the adherend surface.

The reactive emulsifiers may also be available as commercial products typically under the trade name of “ADEKA REASOAP SE-10N” (from ADEKA CORPORATION), under the trade name of “AQUALON HS-10” (from Dai-ichi Kogyo Seiyaku Co., Ltd.), and under the trade name of “AQUALON HS-05” (from Dai-ichi Kogyo Seiyaku Co., Ltd.).

The reactive emulsifier for use herein is preferably one having a SO₄²⁻ ion concentration of 100 μg/g or less, from which impurity ions have been removed. This is because such impurity ions may become a problem. The anionic reactive emulsifier, when used, is preferably an ammonium salt reactive emulsifier. Impurities can be removed from the reactive emulsifier by a suitable process such as a process using an ion-exchange resin, a membrane separation process, or an impurities precipitation-filtration process with an alcohol.

The reactive emulsifier may be blended (used) in an amount of preferably from 0.1 to 10 parts by weight, more preferably from 0.5 to 6 parts by weight, and furthermore preferably from 1 to 4.5 parts by weight, per 100 parts by weight of the total amount of constitutive monomers (entire constitutive monomers) constituting the acrylic emulsion polymer. The reactive emulsifier, when blended in an amount of 0.1 part by weight or more, can advantageously maintain stable emulsification. In contrast, the reactive emulsifier, when blended in an amount of 10 parts by weight or less, may readily help the acrylic pressure-sensitive adhesive layer after crosslinking to have a solvent-insoluble content controlled within the range specified in the present invention and help the pressure-sensitive adhesive (pressure-sensitive adhesive layer) to have higher cohesive force to less cause stains on the adherend. In addition, the emulsifier itself less causes staining.

The polymerization initiator for use in emulsion polymerization to form the acrylic emulsion polymer is exemplified by, but not limited to, azo polymerization initiators such as 2,2′-azobisisobutyronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine)disulfate, and 2,2′-azobis(N,N′-dimethyleneisobutyramidine); persulfates such as potassium peroxodisulfate and ammonium persulfate; peroxide polymerization initiators such as benzoyl peroxide, t-butyl hydroperoxide, and hydrogen peroxide; redox initiators using a peroxide in combination with a reducing agent, such as redox polymerization initiators using a peroxide in combination with ascorbic acid (e.g., hydrogen peroxide water in combination with ascorbic acid), those using a peroxide in combination with an iron(II) salt (e.g., hydrogen peroxide water in combination with an iron(II) salt), and those using a persulfate in combination with sodium hydrogen-sulfite. Each of different polymerization initiators may be used alone or in combination.

The amount of the polymerization initiator to be blended (used) can be suitably determined according typically to the types of the initiator and constitutive monomers and is not critical. Typically for controlling the solvent-insoluble content of the acrylic pressure-sensitive adhesive layer within a preferred range, the amount is preferably from 0.01 to 1 part by weight and more preferably from 0.02 to 0.5 part by weight, per 100 parts by weight of the total amount of constitutive monomers (entire constitutive monomers) constituting the acrylic emulsion polymer.

The emulsion polymerization to form the acrylic emulsion polymer may be performed by any process not limited, such as general batch polymerization, continuous dropping polymerization, or portion-wise dropping polymerization. The emulsion polymerization is preferably performed by batch polymerization at a low temperature (typically 55° C. or lower, and preferably 30° C. or lower). These conditions are preferred for less causing staining and for controlling the solvent-insoluble content and elongation at breaking point of the acrylic pressure-sensitive adhesive layer after crosslinking within preferred ranges. This is probably because polymerization under these conditions readily gives a high-molecular-weight component and less gives a low-molecular-weight component to thereby less cause staining.

The acrylic emulsion polymer is a polymer including, as essential constitutional units, constitutional units derived from the (meth)acrylic alkyl ester (A), and constitutional units derived from the carboxyl-containing unsaturated monomer (B). Above all, the acrylic emulsion polymer is preferably a polymer including, as essential constitutional units, constitutional units derived from the (meth)acrylic alkyl ester (A); constitutional units derived from the carboxyl-containing unsaturated monomer (B); and constitutional units derived from the monomer (C). The constitutional units derived from the (meth)acrylic alkyl ester (A) may be contained in the acrylic emulsion polymer in a content of from 70 to 99.5 percent by weight, preferably from 70 to 99 percent by weight, more preferably from 85 to 98 percent by weight, and furthermore preferably from 87 to 96 percent by weight. The constitutional units derived from the carboxyl-containing unsaturated monomer (B) may be contained in the acrylic emulsion polymer in a content of from 0.5 to 10 percent by weight, preferably from 1 to 5 percent by weight, and more preferably from 2 to 4 percent by weight. The constitutional units derived from the monomer (C) may be contained in the acrylic emulsion polymer in a content of preferably from 0.5 to 10 percent by weight, more preferably from 1 to 6 percent by weight, and furthermore preferably from 2 to 5 percent by weight.

The acrylic emulsion polymer may have a solvent-insoluble content (a content of solvent-insoluble matter; also referred to as “gel fraction”) of preferably 70% (percent by weight) or more, more preferably 75 percent by weight or more, and furthermore preferably 80 percent by weight or more, from the viewpoints of causing less staining and obtaining an appropriate adhesive strength. The acrylic emulsion polymer, if having a solvent-insoluble content of less than 70 percent by weight, may contain large amounts of low-molecular-weight components and fail to sufficiently contribute to reduction in low-molecular-weight components in the resulting pressure-sensitive adhesive layer merely by crosslinking. Such low-molecular-weight components may stain the adherend or cause an excessively high adhesive strength. The solvent-insoluble content can be controlled typically by the polymerization initiator, the reaction temperature, and the types of the emulsifier and constitutive monomers. The upper limit of the solvent-insoluble content is not critical, but typically 99 percent by weight.

As used herein the term “solvent-insoluble content” of the acrylic emulsion polymer refers to a value determined by a “solvent-insoluble content measurement method” as follows:

Solvent-Insoluble Content Measurement Method

About 0.1 g of the acrylic emulsion polymer is sampled to give a specimen, the specimen is covered by a porous tetrafluoroethylene sheet (trade name “NTF1122” supplied by Nitto Denko Corporation) having an average pore size of 0.2 μm, tied with a kite string, and the weight of the resulting article is measured and defined as a “weight before immersion.” The weight before immersion is the total weight of the acrylic emulsion polymer (the sampled specimen), the tetrafluoroethylene sheet, and the kite string. Independently, the total weight of the tetrafluoroethylene sheet and the kite string is measured and defined as a “tare weight.”

Next, the specimen acrylic emulsion polymer covered by the tetrafluoroethylene sheet and tied with the kite string (this article is hereinafter referred to as “sample”) is placed in ethyl acetate filled in a 50-ml vessel, and left stand therein at 23° C. for 7 days. The sample (after ethyl acetate treatment) is retrieved from the vessel, transferred to an aluminum cup, dried in a drier at 130° C. for 2 hours to remove ethyl acetate, the weight of the dried article is measured and defined as a “weight after immersion.”

Based on these, the solvent-insoluble content is calculated according to an equation as follows:

Solvent-insoluble content(percent by weight)=(a−b)/(c−b)×100 (1)

wherein “a” represents the weight after immersion; “b” represents the tare weight; and “c” represents the weight before immersion.

The acrylic emulsion polymer may have a weight-average molecular weight (Mw) of a solvent-soluble fraction (hereinafter also referred to as a “sol fraction”) not critical, but preferably from 4×10⁴ to 20×10⁴, more preferably from 5×10⁴ to 15×10⁴, and furthermore preferably from 6×10⁴ to 10×10⁴. The acrylic emulsion polymer, when having a weight-average molecular weight of a solvent-soluble fraction of 4×10⁴ or more, may help the pressure-sensitive adhesive composition to exhibit better wettability with, and better adhesiveness to, the adherend. The acrylic emulsion polymer, when having a weight-average molecular weight of a solvent-soluble fraction of 20×10⁴ or less, may help the pressure-sensitive adhesive composition to less remain on the adherend and to less cause staining thereon.

The weight-average molecular weight of the solvent-soluble fraction in the acrylic emulsion polymer can be determined by air-drying an extract (ethyl acetate solution) at room temperature to give a sample (solvent-soluble fraction of the acrylic emulsion polymer), in which the extract is obtained after the ethyl acetate treatment in the measurement of the solvent-insoluble content of the acrylic emulsion polymer; and measuring the weight-average molecular weight of the sample by gel permeation chromatography (GPC). An exemplary measurement method is as follows:

Measurement Method

The GPC measurement is performed using a GPC analyzer “HLC-8220GPC” supplied by Tosoh Corporation to determine a molecular weight in terms of a polystyrene standard. Measurement conditions are as follows:

Sample concentration: 0.2 percent by weight (THF solution)

Sample volume: 10 μl

Eluting solvent: THF

Flow rate: 0.6 ml/min

Measurement temperature: 40° C.

Columns: Sample columns; one TSKguardcolumn SuperHZ-H column and two TSKgel SuperHZM-H columns
Reference column; one TSKgel SuperH-RC column

Detector: differential refractive index detector

The pressure-sensitive adhesive composition for use in the present invention may contain the acrylic emulsion polymer in a content not critical, but preferably 80 percent by weight or more and more preferably from 90 to 99 percent by weight, based on the total amount (100 percent by weight) of non-volatile components in the pressure-sensitive adhesive composition.

Water-Insoluble Crosslinking Agent

As is described above, the pressure-sensitive adhesive composition for use in the present invention preferably further contains a water-insoluble crosslinking agent having two or more carboxyl-reactive functional groups in molecule (per molecule), in addition to the acrylic emulsion polymer. The water-insoluble crosslinking agent is a compound that is insoluble in water and has two or more (e.g., two to six) carboxyl-reactive functional groups in molecule (per molecule). The water-insoluble crosslinking agent preferably has three to five carboxyl-reactive functional groups per molecule. With an increasing number of carboxyl-reactive functional groups per molecule, the pressure-sensitive adhesive composition undergoes denser crosslinking. Specifically, the polymer constituting the pressure-sensitive adhesive layer has a denser crosslinked structure. This can prevent the spread by wetting of the pressure-sensitive adhesive layer after its formation. In addition, such dense crosslinked structure constrains the polymer constituting the pressure-sensitive adhesive layer and thereby prevents increase in adhesive strength between the pressure-sensitive adhesive layer and the adherend with time. The adhesive strength increase with time is caused by segregation of functional groups (carboxyl groups) in the pressure-sensitive adhesive layer to the surface in contact with the adherend. In contrast, the water-insoluble crosslinking agent, if having carboxyl-reactive functional groups in an excessively large number of more than 6 per molecule, may cause the formation of a gelled substance.

The carboxyl-reactive functional groups in the water-insoluble crosslinking agent are exemplified by, but not limited to, epoxy groups, isocyanate groups, and carbodiimide groups. Among them, epoxy groups are preferred from the viewpoint of reactivity. Among epoxy groups, glycidylamino group is more preferred, because this group is highly reactive, less causes unreacted components in the crosslinking reaction, advantageously contributes to less staining, and can prevent an increasing adhesive strength to the adhered with time, which increase is caused by unreacted carboxyl groups in the pressure-sensitive adhesive layer. Specifically, the water-insoluble crosslinking agent is preferably any of epoxy crosslinking agents having epoxy groups, of which crosslinking agents having glycidylamino groups (glycidylamino crosslinking agents) are more preferred. The water-insoluble crosslinking agent, when being an epoxy crosslinking agent (particularly a glycidylamino crosslinking agent), may have epoxy groups (particularly glycidylamino groups) in a number of preferably 2 or more (e.g., from 2 to 6), and more preferably from 3 to 5 per molecule.

The water-insoluble crosslinking agent is a water-insoluble compound. As used herein the term “water-insoluble” refers to that the compound (crosslinking agent) has a solubility of 5 parts by weight or less in 100 parts by weight of water at 25° C. The solubility is a weight of the compound (crosslinking agent) soluble in 100 parts by weight of water. The solubility is preferably 3 parts by weight or less and furthermore preferably 2 parts by weight or less. The water-insoluble crosslinking agent, when used, may less cause clouding as stain on the adherend to further less cause staining. The clouding as stain is caused in a high-humidity environment by a crosslinking agent which has not undergone crosslinking and remains in the resulting polymer. A water-soluble crosslinking agent, if used and remained in the polymer and exposed to a high-humidity environment, may be readily dissolved in water and transfer or migrate to the adherend and readily cause clouding as stain. The water-insoluble crosslinking agent more contributes to the crosslinking reaction (reaction with carboxyl group) and more effectively prevents adhesive strength increase with time than the water-soluble crosslinking agent does. In addition, the water-insoluble crosslinking agent exhibits high reactivity to proceed the crosslinking reaction, and this helps the crosslinking reaction to proceed rapidly through aging and can prevent an increasing adhesive strength to the adherend with time, which increase is caused by unreacted carboxyl groups in the pressure-sensitive adhesive layer.

The water solubility of the crosslinking agent can be measured typically by a method as follows:

Water Solubility Measurement Method

Water (25° C.) and a sample crosslinking agent in equal weights are mixed with a stirrer at 300 revolutions per minute (rpm) for 10 minutes, and the mixture is separated into an aqueous phase and an oily phase by centrifugal separation. Next, the aqueous phase is collected, dried at 120° C. for one hour, a weight loss on drying is determined, from which a non-volatile content in the aqueous phase (part by weight of non-volatile components per 100 parts by weight of water) is determined.

Specific examples of the water-insoluble crosslinking agent include glycidylamino crosslinking agents such as 1,3-bis(N,N-diglycidylaminomethyl)cyclohexane (e.g., trade name “TETRAD-C” supplied by MITSUBISHI GAS CHEMICAL COMPANY, INC.) [solubility in 100 parts by weight of water at 25° C.: 2 parts by weight or less], and 1,3-bis(N,N-diglycidylaminomethyl)benzene (e.g., trade name “TETRAD-X” supplied by MITSUBISHI GAS CHEMICAL COMPANY, INC.) [solubility in 100 parts by weight of water at 25° C.: 2 parts by weight or less]; and other epoxy crosslinking agents such as Tris(2,3-epoxypropyl)isocyanurate (e.g., trade name “TEPIC-G” supplied by Nissan Chemical Industries, Ltd.) [solubility in 100 parts by weight of water at 25° C.: 2 parts by weight or less]. Each of different water-insoluble crosslinking agents may be used alone or in combination.

The water-insoluble crosslinking agent may be blended preferably in such an amount (content in the pressure-sensitive adhesive composition for use in the present invention) that the water-insoluble crosslinking agent contains carboxyl-reactive functional groups in an amount of from 0.4 to 1.3 moles per 1 mole of carboxyl groups in the carboxyl-containing unsaturated monomer (B) serving as a constitutive monomer to form the acrylic emulsion polymer. Specifically, a ratio (molar ratio) [(carboxyl-reactive functional group)/(carboxyl group)] is preferably from 0.4 to 1.3, more preferably from 0.5 to 1.1, and furthermore preferably from 0.5 to 1.0, where the ratio is the ratio of the “total number of moles of carboxyl-reactive functional groups in entire water-insoluble crosslinking agents” to the “total number of moles of carboxyl groups in entire carboxyl-containing unsaturated monomers (B) used as constitutive monomers to form the acrylic emulsion polymer.” The ratio [(carboxyl-reactive functional group)/(carboxyl group)] is preferably controlled to 0.4 or more to reduce unreacted carboxyl groups in the pressure-sensitive adhesive layer and to effectively prevent adhesive strength increase with time, which increase is caused by an interaction between the carboxyl group and the adherend. This control is also preferred for easy control of the solvent-insoluble content and the elongation at breaking point of the acrylic pressure-sensitive adhesive layer after crosslinking within ranges specified in the present invention. The ratio is also preferably controlled to 1.3 or less to reduce an unreacted water-insoluble crosslinking agent in the pressure-sensitive adhesive layer, to suppress visual defects caused by the water-insoluble crosslinking agent, and to provide better visual quality.

Particularly when the water-insoluble crosslinking agent is an epoxy crosslinking agent, the ratio (molar ratio) of epoxy group to carboxyl group [epoxy group/carboxyl group] is preferably from 0.4 to 1.3, more preferably from 0.5 to 1.1, and furthermore preferably from 0.5 to 1.0. When the water-insoluble crosslinking agent is a glycidylamino crosslinking agent, the ratio (molar ratio) of glycidylamino group to carboxyl group [glycidylamino group/carboxyl group] preferably falls within the above-specified range.

Typically, when 4 grams of a water-insoluble crosslinking agent having a functional group equivalent of carboxyl-reactive functional groups of 110 (g/eq) is added (incorporated) to a pressure-sensitive adhesive composition, the number of moles of carboxyl-reactive functional groups of the water-insoluble crosslinking agent may be calculated typically according to an equation as follows:

Number of moles of carboxyl-reactive functional groups of water-insoluble crosslinking agent=[Amount of water−insoluble crosslinking agent to be added (incorporated)]/[Functional-group equivalent]=4/110

For example, when 4 grams of an epoxy crosslinking agent having an epoxy equivalent of 110 (g/eq) is added (incorporated) as the water-insoluble crosslinking agent, the number of moles of epoxy groups of the epoxy crosslinking agent may for example be calculated according to an equation as follows:

Number of moles of epoxy groups of epoxy crosslinking agent=[Amount of epoxy crosslinking agent to be added (incorporated)]/[Epoxy equivalent]=4/110

Water-Dispersible Acrylic Pressure-Sensitive Composition

The pressure-sensitive adhesive composition for use in the present invention contains the acrylic emulsion polymer as an essential component, as described above. The composition preferably further contains the water-insoluble crosslinking agent. The composition may further contain any of other additives according to necessity.

The pressure-sensitive adhesive composition for use in the present invention is a water-dispersible pressure-sensitive adhesive composition. As used herein the term “water-dispersible” refers to that the substance in question is dispersible in an aqueous medium. Specifically, the pressure-sensitive adhesive composition for use in the present invention is a pressure-sensitive adhesive composition dispersible in an aqueous medium. The aqueous medium refers to a medium (dispersion medium) containing water as an essential component and may be water alone or a mixture of water with a water-soluble organic solvent. The pressure-sensitive adhesive composition for use in the present invention may also be a dispersion typically in the aqueous medium.

The pressure-sensitive adhesive composition for use in the present invention preferably contains substantially no so-called non-reactive (non-polymerizable) components. The non-reactive components are components other than reactive (polymerizable) components that react (polymerize) typically with constitutive monomers constituting the acrylic emulsion polymer and are incorporated into the polymer to form the pressure-sensitive adhesive layer. The non-reactive components herein, however, do not include water and other components that evaporate by drying and do not remain in the pressure-sensitive adhesive layer. The non-reactive components, if remaining in the pressure-sensitive adhesive layer, may transfer or migrate to the adherend to cause clouding as stain. The term “contains substantially no” refers to that the substance in question is not positively added, except for the case where the substance is inevitably contaminated. Specifically, the pressure-sensitive adhesive composition has a content of these non-reactive components of preferably less than 1 percent by weight, more preferably less than 0.1 percent by weight, and furthermore preferably less than 0.005 percent by weight, based on the total amount of non-volatile components in the pressure-sensitive adhesive composition.

The non-reactive components are exemplified by phosphoric ester compounds used in JP-A No. 2006-45412 and other compounds that bleed out to a pressure-sensitive adhesive layer surface to impart removability (peelability) to the layer; and non-reactive emulsifiers such as sodium lauryl sulfate and ammonium lauryl sulfate.

Particularly for less staining, the pressure-sensitive adhesive composition for use in the present invention is preferably added with no quaternary ammonium salt, and is more preferably added with no quaternary ammonium compound. Specifically, the pressure-sensitive adhesive composition for use in the present invention preferably contains substantially no quaternary ammonium salt and more preferably contains substantially no quaternary ammonium compound. These compounds are generally used typically as catalysts to increase the reactivity of epoxy crosslinking agents. These compounds, however, are not integrated into the polymer constituting the pressure-sensitive adhesive layer, can freely migrate in the pressure-sensitive adhesive layer, and readily precipitate to the adherend surface. The compounds, if contained in the pressure-sensitive adhesive composition, may therefore often cause clouding as stain and may impede the development of less-staining properties. Specifically, the pressure-sensitive adhesive composition for use in the present invention has a quaternary ammonium salt content of less than 0.1 percent by weight, more preferably less than 0.01 percent by weight, and furthermore preferably less than 0.005 percent by weight, based on the total amount (100 percent by weight) of non-volatile components in the pressure-sensitive adhesive composition. The pressure-sensitive adhesive composition more preferably has a quaternary ammonium compound content falling within the above-specified range.

Specific examples of the quaternary ammonium salt include, but not limited to, compounds represented by a formula as follows:

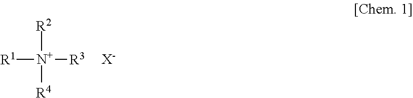

In the formula, R¹, R², R³, and R⁴ each independently represent not hydrogen atom but an alkyl group, an aryl group, or a group derived from them (e.g., a substituted alkyl group or aryl group); and X⁻ represents a counter ion.

The quaternary ammonium salts and quaternary ammonium compounds are exemplified by, but not limited to, alkylammonium hydroxides such as tetramethylammonium hydroxide (TMAH), tetraethylammonium hydroxide, tetrapropylammonium hydroxide, and tetrabutylammonium hydroxide, and salts of them; arylammonium hydroxides such as tetraphenylammonium hydroxide, and salts of them; and bases and salts of them, which bases including, as a cation, any of trilaurylmethylammonium ion, didecyldimethylammonium ion, dicocoyldimethylammonium ion, distearyldimethylammonium ion, dioleyldimethylammonium ion, cetyltrimethylammonium ion, stearyltrimethylammonium ion, behenyltrimethylammonium ion, cocoylbis(2-hydroxyethyl)methylammonium ion, polyoxyethylene(15) coco-stearylmethylammonium ion, oleylbis(2-hydroxyethyl)methylammonium ion, coco-benzyldimethylammonium ion, laurylbis(2-hydroxyethyl)methylammonium ion, and decylbis(2-hydroxyethyl)methylammonium ion.

Also from the viewpoint of less staining, the pressure-sensitive adhesive composition for use in the present invention is preferably not added with tertiary amines and imidazole compounds. Such tertiary amines and imidazole compounds are generally used typically as catalysts for improving the reactivity of epoxy crosslinking agents, as with the quaternary ammonium salts (or quaternary ammonium compounds). Specifically, the pressure-sensitive adhesive composition for use in the present invention preferably contains substantially no tertiary amine and substantially no imidazole compound. Specifically, the pressure-sensitive adhesive composition for use in the present invention has a content of tertiary amines and imidazole compounds (total content of tertiary amines and imidazole compounds) of preferably less than 0.1 percent by weight, more preferably less than 0.01 percent by weight, and furthermore preferably less than 0.005 percent by weight, based on the total amount (100 percent by weight) of non-volatile components in the pressure-sensitive adhesive composition.

The tertiary amines are exemplified by tertiary amine compounds such as triethylamine, benzyldimethylamine, and α-methylbenzyl-dimethylamine. The imidazole compounds are exemplified by 2-methylimidazole, 2-heptadecylimidazole, 2-phenylimidazole, 4-ethylimidazole, 4-dodecylimidazole, 2-phenyl-4-hydroxymethylimidazole, 2-ethyl-4-hydroxymethylimidazole, 1-cyanoethyl-4-methylimidazole, and 2-phenyl-4,5-dihydroxymethylimidazole.

The pressure-sensitive adhesive composition for use in the present invention may further contain any of various additives in addition to the above components, within ranges not adversely affecting the less-staining properties. The additives are exemplified by pigments, fillers, leveling agents, dispersing agents, plasticizers, stabilizers, antioxidants, ultraviolet absorbers, ultraviolet stabilizers, antifoaming agents, age inhibitors, and antiseptic agents.

The pressure-sensitive adhesive composition for use in the present invention can be prepared by mixing the acrylic emulsion polymer, where necessary with the water-insoluble crosslinking agent and optional additives. The mixing can be performed by any known or customary technique for mixing an emulsion, but typically by stirring with a stirrer. Though stirring conditions are not limited, the stirring may be performed at a temperature of preferably from 10° C. to 50° C. and more preferably from 20° C. to 35° C. for a duration of preferably from 5 to 30 minutes and more preferably from 10 to 20 minutes at a number of revolutions of preferably from 10 to 3000 rpm and more preferably from 30 to 1000 rpm.

The pressure-sensitive adhesive composition for use in the present invention can form a pressure-sensitive adhesive layer (acrylic pressure-sensitive adhesive layer). A way to form the acrylic pressure-sensitive adhesive layer is not limited and can be any of known or customary methods to form pressure-sensitive adhesive layers. Typically, the acrylic pressure-sensitive adhesive layer can be formed by applying the pressure-sensitive adhesive composition for use in the present invention onto the substrate (transparent film substrate) or a release film (release liner), and drying and/or curing the applied layer according to necessity. Crosslinking may be performed typically by heating the acrylic pressure-sensitive adhesive layer after dehydration and drying in the drying step.

The application (coating) in the technique to form the acrylic pressure-sensitive adhesive layer can be performed by a known coating technique and may employ any of customary coaters such as rotogravure roll coaters, reverse roll coaters, kiss-contact roll coaters, dip roll coaters, bar coaters, knife coaters, spray coaters, comma coaters, and direct coaters.

The acrylic pressure-sensitive adhesive layer in the pressure-sensitive adhesive sheet according to the present invention may have a thickness not critical, but preferably from 1 to 50 μm, more preferably from 1 to 35 μm, and furthermore preferably from 3 to 25 μm.

The acrylic pressure-sensitive adhesive layer (after crosslinking) may have a solvent-insoluble content not critical, but preferably 90 percent by weight or more and more preferably 95 percent by weight or more. The acrylic pressure-sensitive adhesive layer, if having a solvent-insoluble content of less than 90 percent by weight, may cause contaminants to transfer or migrate to the adherend in a larger amount to cause clouding as stain or may have insufficient removability (may be released more heavily). Though not critical, the upper limit of the solvent-insoluble content of the acrylic pressure-sensitive adhesive layer is typically preferably 99 percent by weight.

The solvent-insoluble content of the acrylic pressure-sensitive adhesive layer (after crosslinking) can be measured by the same procedure as with the method for measuring the solvent-insoluble content of the acrylic emulsion polymer. Specifically, the solvent-insoluble content herein can be measured by a procedure corresponding to the “solvent-insoluble content measurement method”, except that the term “acrylic emulsion polymer” is read as “acrylic pressure-sensitive adhesive layer (after crosslinking).”

The acrylic pressure-sensitive adhesive layer (after crosslinking) has an elongation at breaking point at 23° C. of preferably 130% or less, more preferably from 40% to 120%, and furthermore preferably from 60% to 115%. The elongation at breaking point is an index of the degree of crosslinking of the acrylic pressure-sensitive adhesive layer and, if being 130% or less, the polymer constituting the acrylic pressure-sensitive adhesive layer has a dense crosslinked structure. This enables the prevention of the spread by wetting of the acrylic pressure-sensitive adhesive layer after its formation. In addition, such dense crosslinked structure constrains the polymer constituting the acrylic pressure-sensitive adhesive layer and thereby prevents increase in adhesive strength to the adherend with time due to segregation of the functional groups (carboxyl groups) in the pressure-sensitive adhesive layer to the surface in contact with the adherend.

The elongation at breaking point at 23° C. of the acrylic pressure-sensitive adhesive layer (after crosslinking) can be measured by a tensile test. Specifically, though not limited, the elongation at breaking point can be determined typically by rounding the acrylic pressure-sensitive adhesive layer (after crosslinking) to give a cylindrical sample having a length of 50 mm and a cross-sectional area (base area) of 1 mm², subjecting the sample to a tensile test using a tensile tester at an ambient temperature of 23° C. and relative humidity of 50%, with an initial length (chuck-to-chuck distance) of 10 mm at a tensile speed of 50 mm/min, and an elongation at breaking point (at rupture) is measured.

More specifically, the acrylic pressure-sensitive adhesive layer (after crosslinking) to be used in the tensile test can be prepared typically by a method as follows.

The pressure-sensitive adhesive composition for use in the present invention is applied onto a suitable release film so as to have a dry thickness of 50 μm, dried in an oven with internal air circulation at 120° C. for 2 minutes, further aged at 50° C. for 3 days, and yields the acrylic pressure-sensitive adhesive layer. The release film is not limited, but can be a PET film having a surface treated with a silicone. Such release film is also available typically as “MRF38” from Mitsubishi Plastics, Inc.

The acrylic polymer (after crosslinking) constituting the acrylic pressure-sensitive adhesive layer may have a glass transition temperature not critical, but preferably from −70° C. to −10° C., more preferably from −70° C. to −20° C., furthermore preferably from −70° C. to −40° C., and most preferably from −70° C. to −60° C. The acrylic polymer, if having a glass transition temperature of higher than −10° C., may cause an insufficient adhesive strength to thereby suffer from gaps and/or separation typically upon working. The acrylic polymer, if having a glass transition temperature of lower than −70° C., may cause less removable when peeled off at higher peel rates (at higher tensile speeds), thus inviting insufficient working efficiency. The glass transition temperature of the acrylic polymer (after crosslinking) constituting the acrylic pressure-sensitive adhesive layer can also be adjusted typically by the monomer formulation (monomer composition) in the preparation of the acrylic emulsion polymer.

The acrylic pressure-sensitive adhesive layer (pressure-sensitive adhesive layer derived from the pressure-sensitive adhesive composition for use in the present invention) is provided on at least one side of the transparent film substrate to give a pressure-sensitive adhesive sheet according to the present invention. The pressure-sensitive adhesive sheet according to the present invention may be obtained by a direct process. In the direct process, the pressure-sensitive adhesive composition for use in the present invention is applied to at least one surface of the transparent film substrate, and is crosslinked according to necessity. The crosslinking may be performed typically by heating the pressure-sensitive adhesive sheet after dehydration and drying in the drying step. The pressure-sensitive adhesive sheet according to the present invention may also be obtained by a transfer process. In the transfer process, the acrylic pressure-sensitive adhesive layer is once provided on a release film, and the acrylic pressure-sensitive adhesive layer is then transferred onto the transparent film substrate. The acrylic pressure-sensitive adhesive layer in the pressure-sensitive adhesive sheet according to the present invention is preferably provided by the so-called direct process, in which the pressure-sensitive adhesive composition is directly applied to a surface of the transparent film substrate. This is because the acrylic pressure-sensitive adhesive layer has a high solvent-insoluble content and, if provided by the transfer process, may fail to have sufficient anchoring capability (adhesion) to the transparent film substrate. However, the pressure-sensitive adhesive sheet according to the present invention is not limited in its production method, as long as being a pressure-sensitive adhesive sheet including the substrate and, on at least one side thereof, a pressure-sensitive adhesive layer derived from the pressure-sensitive adhesive composition.

The pressure-sensitive adhesive sheet according to the present invention may have a total luminous transmittance in the visible light region not critical, but preferably from 80% to 97% and more preferably from 85% to 95%, as determined according to JIS K7361-1. The pressure-sensitive adhesive sheet according to the present invention may have a haze not critical, but preferably from 1.0% to 3.5% and more preferably from 2.0% to 3.2%, as determined according to JIS K7136. The pressure-sensitive adhesive sheet, if having a total luminous transmittance and/or a haze out of the above-specified range, may often impede the visual inspection of the adherend with the pressure-sensitive adhesive sheet.

The top coat layer surface of the transparent film substrate, namely, the top coat layer surface of the pressure-sensitive adhesive sheet according to the present invention may have a surface resistivity not critical, but preferably 100×10⁸ Ω/square or less (e.g., from 0.1×10⁸ to 100×10⁸ Ω/square), more preferably 50×10⁸ Ω/square or less (e.g., from 0.1×10⁸ to 50×10⁸ Ω/square), and furthermore preferably from 1×10⁸ to 50×10⁸ Ω/square. The pressure-sensitive adhesive sheet, when having a surface resistivity of 100×10⁸ Ω/square or less on the top coat surface, is usable particularly as a surface-protecting film typically upon working or transportation process of static-sensitive articles such as liquid crystal cells and semiconductor devices. The surface resistivity can be calculated from a surface resistance as measured at an ambient temperature of 23° C. and relative humidity of 55% using a commercially available insulation resistance measurement instrument. Specifically, a surface resistivity obtained by a surface resistivity measurement method described in Examples can be preferably employed.

The top coat layer surface of the transparent film substrate, namely, the top coat layer surface of the pressure-sensitive adhesive sheet according to the present invention may have a frictional coefficient not critical, but preferably 0.4 or less. When the frictional coefficient on the top coat layer surface is controlled 0.4 or less and when the top coat layer surface of the pressure-sensitive adhesive sheet receives a load (such a load as to cause scratching (scratches)), the pressure-sensitive adhesive sheet can turn the load aside along the top coat layer surface and can have a smaller frictional force. This further satisfactorily prevents a phenomenon in which the top coat layer undergoes cohesive failure or is separated from the base layer (interfacial failure) to cause scratches. The lower limit of the frictional coefficient is not critical, but is typically preferably 0.1 and more preferably 0.15 in consideration of balance with other properties such as visual quality and printability. Specifically, the frictional coefficient is not critical, but preferably from 0.1 to 0.4 and more preferably from 0.15 to 0.4.

The frictional coefficient can for example be a value determined by rubbing the top coat layer surface of the transparent film substrate (or of the pressure-sensitive adhesive sheet according to the present invention) with a vertical load of 40 mN and performing a measurement at an ambient temperature of 23° C. and relative humidity of 50%. The frictional coefficient can be reduced (controlled) by a suitable technique as selected typically from a technique of incorporating any of various lubricants (e.g., leveling agents) into the top coat layer; and a technique of allowing the top coat layer to be more densely crosslinked through addition of a crosslinking agent or regulation of film-forming conditions.

In a preferred embodiment, the top coat layer surface of the transparent film substrate, namely, the top coat layer surface of the pressure-sensitive adhesive sheet according to the present invention has such a property as to be easily printable with an oil-based ink or a water-based ink (e.g., with an oil-based marker). This property is hereinafter also referred to as “printability.” The surface-protecting film (pressure-sensitive adhesive sheet) according to this embodiment is suitably used, when laminated with an adherend (e.g., an optical component) to be protected, for the indication typically of the identification number on the surface-protecting film during a process typically of working or transportation of the adherend with the surface-protecting film. The pressure-sensitive adhesive sheet according to the present invention preferably serves as a surface-protecting film excellent both in visual quality and printability and particularly preferably serves as a surface-protecting film having high printability with an oil-based ink containing a pigment in an alcoholic solvent. The pressure-sensitive adhesive sheet also preferably has such a property as to be resistant to rub-off of printed ink by friction or transferring. This property is also referred to as “ink adhesion.” The level of printability can be assessed typically by a printability evaluation as follows.

Printability (Ink Adhesion) Evaluation

The top coat surface is printed with an Xstamper supplied by Shachihata Inc.; on top of the print, is affixed a cellophane pressure-sensitive adhesive tape (product No. 405, 19 mm width) supplied by Nichiban Co., Ltd.; and the tape is peeled off at a peel speed of 30 m/min at a peel angle of 180 degrees. The post-peeling surface is visually observed. This measurement is performed at an ambient temperature of 23° C. and relative humidity of 50%. A sample having a peeled area of the print of 50% or larger is evaluated as being poor (having poor printability); whereas a sample having an unpeeled area of the print of 50% or larger is evaluated as being good (having good printability).

The top coat layer surface of the transparent film substrate, namely, top coat layer surface of the pressure-sensitive adhesive sheet according to the present invention preferably has solvent resistance at such a level where rubbing off the ink with an alcohol (e.g., ethanol) for modification or deletion would not cause significant changes (cloudiness) to the appearance. The solvent resistance level can be assessed typically by a solvent resistance evaluation as follows.

Solvent Resistance Evaluation

In a dark room blocked from outside light, the surface of the top coat layer is wiped 15 times with a cleaning cloth (fabric) wetted with ethanol, and the appearance of the surface is visually observed. A sample having no visual change between regions wiped with ethanol and the other regions (indicating no visual change due to wiping with ethanol) is evaluated as being good (having good solvent resistance); whereas a sample indicating wiping streaks is evaluated as being poor (having poor solvent resistance.

The pressure-sensitive adhesive sheet according to the present invention has an adhesive strength to a polarizing plate (a triacetyl cellulose (TAC) plate) of preferably from 0.01 to 5 N/25 mm, more preferably from 0.05 to 2 N/25 mm, and furthermore preferably from 0.1 to 1 N/25 mm as determined by a 180-degree peel test at a tensile speed of 30 m/min. The polarizing plate to be used herein is one having an arithmetic mean surface roughness Ra of 50 nm or less. The “adhesive strength” refers to a release force upon peeling of the pressure-sensitive adhesive sheet adhered to the polarizing plate. The pressure-sensitive adhesive sheet, when having the adhesive strength of 5 N/25 mm or less, may be advantageously easily to peel off and contribute to better productivity and handleability in the production process of a polarizing plate or a liquid crystal display device. The pressure-sensitive adhesive sheet, when having the adhesive strength of 0.01 N/25 mm or more, may less suffer from gaps and separation in production process and advantageously sufficiently exhibit the protection function as a surface-protecting pressure-sensitive adhesive sheet. The arithmetic mean surface roughness Ra can be measured typically with KLA-Tencor P-15 (stylus surface profilometer). The surface roughness (arithmetic mean surface roughness Ra) measurement can be performed typically at a measurement length of 1000 μm, a scanning speed of 50 μm/sec, and a scanning time of one pass under a load of 2 mg.

The pressure-sensitive adhesive sheet according to the present invention is satisfactorily resistant to increase in adhesive strength to the adherend with time. This property can be evaluated by the difference between an adhesive strength after one-week application/storage at 40° C. and an initial adhesive strength, of the pressure-sensitive adhesive sheet according to the present invention. The pressure-sensitive adhesive sheet according to the present invention has a difference between the adhesive strength after one-week application/storage at 40° C. and the initial adhesive strength [(adhesive strength after one-week application/storage at 40° C.)−(initial adhesive strength)] of preferably less than 0.5 N/25 mm and more preferably from 0.0 to 0.2 N/25 mm. The pressure-sensitive adhesive sheet, if having the difference between the adhesive strength after one-week application/storage at 40° C. and the initial adhesive strength of 0.5 N/25 mm or more, may have inferior resistance to adhesive strength increase and exhibit insufficient removal workability.

As used herein the term “initial adhesive strength” refers to an adhesive strength of a pressure-sensitive adhesive sheet to a polarizing plate (a triacetyl cellulose (TAC) plate) as determined by laminating the pressure-sensitive adhesive sheet to the polarizing plate at 0.25 MPa and 0.3 m/min, leaving the resulting article stand at an ambient temperature of 23° C. and relative humidity of 50% for 20 minutes, and measuring an adhesive strength by a 180-degree peel test, in which the polarizing plate is one having an arithmetic mean surface roughness Ra of 50 nm or less. Also as used herein the term “adhesive strength after one-week application/storage at 40“C” is an adhesive strength of a pressure-sensitive adhesive sheet to a polarizing plate (a triacetyl cellulose plate) as determined by laminating the pressure-sensitive adhesive sheet to the polarizing plate at 0.25 MPa and 0.3 m/min, storing the resulting article at an ambient temperature of 40° C. for one week, leaving the article at an ambient temperature of 23° C. and relative humidity of 50% for 2 hours, and measuring an adhesive strength by a 180-degree peel test, in which the polarizing plate is one having an arithmetic mean surface roughness Ra of 50 nm or less. The 180-degree peel test can be performed with a tensile tester at a tensile speed of 30 m/min at an ambient temperature of 23° C. and relative humidity of 50%.

The pressure-sensitive adhesive sheet according to the present invention satisfactorily less causes clouding as stain on the adherend. This can be evaluated typically in the following manner. A sample pressure-sensitive adhesive sheet is laminated onto a polarizing plate (trade name “SEG1425DUHC”, supplied by Nitto Denko Corporation) at 0.25 MPa and 0.3 m/min, the resulting article is left stand at 80° C. for 4 hours, and the pressure-sensitive adhesive sheet is removed from the polarizing plate. The polarizing plate, from which the pressure-sensitive adhesive sheet has been removed, is further left stand at an ambient temperature of 23° C. and relative humidity of 90% for 12 hours, and the surface thereof is observed. It is preferred that no clouding is observed in the resulting polarizing plate surface. A pressure-sensitive adhesive sheet causing clouding on the adherend polarizing plate under humidified conditions (high-humidity conditions) after the application and removal of the pressure-sensitive adhesive sheet may have insufficient less-staining properties as a surface-protecting film for an optical member.

The pressure-sensitive adhesive sheet according to the present invention can be formed into a roll and can be wound into a roll with a release film (separator) protecting the pressure-sensitive adhesive layer. The backside of the pressure-sensitive adhesive sheet may bear a back treatment layer (e.g., a surface release treatment layer or a soil-resistant layer) as formed by a surface release treatment and/or a soil resistant finishing typically with any of releasing agents such as silicone, fluorochemical, long-chain alkyl, or fatty amide releasing agents; and silica powders. The term “backside” refers to a side opposite to the side bearing the pressure-sensitive adhesive layer and is generally the top coat layer surface. Above all, the pressure-sensitive adhesive sheet according to the present invention preferably has a structure of [(acrylic pressure-sensitive adhesive layer)/(transparent film substrate)/(back treatment layer)].

The pressure-sensitive adhesive sheet according to the present invention has adhesiveness and removability (easiness to peel) at satisfactory levels, can be removed, and is used in applications where the sheet will be removed (for removal use). Specifically, the pressure-sensitive adhesive sheet according to the present invention is used in applications where the sheet will be removed. Such applications are exemplified by masking tapes such as masking tapes for protection or curing in construction, masking tapes for automobile painting, masking tapes for electronic components (e.g., lead frames and printed circuit boards), and masking tapes for sand blasting; surface-protecting films such as surface-protecting films for aluminum sash, surface-protecting films for optical plastics, surface-protecting films for optical glass, surface-protecting films for automobiles, and surface-protecting films for metal plates; pressure-sensitive adhesive tapes for use in production processes of semiconductor/electronic components, such as backgrinding tapes, pellicle-fixing tapes, dicing tapes, lead-frame-fixing tapes, cleaning tapes, dedusting tapes, carrier tapes, and cover tapes; packaging tapes for electronic appliances and electronic components; temporal tacking tapes upon transportation; binding tapes; and labels.

In addition, the pressure-sensitive adhesive sheet according to the present invention is resistant to clouding during storage under humid conditions (hygroscopic clouding). The pressure-sensitive adhesive sheet does not appear cloudy even having the top coat layer on the surface, thereby has superior visual quality, and is satisfactorily resistant to scratches and static electrification. The pressure-sensitive adhesive sheet, when applied to an adherend, does not cause staining, such as clouding, on the adherend and satisfactorily less causes staining. In an embodiment, the pressure-sensitive adhesive sheet employs the acrylic emulsion polymer having the specific formulation including the monomer (C) as a monomer component. This pressure-sensitive adhesive sheet less suffers from visual defects, such as “dimples” and “gelled substance”, of the pressure-sensitive adhesive layer and has further superior visual quality. For these reasons, the pressure-sensitive adhesive sheet according to the present invention is preferably used for the surface protection of optical members (e.g., optical plastics, optical glass, and optical films) typically as a surface-protecting film for an optical member, in which the optical members require not only resistance to clouding during storage under humid conditions, but also other properties such as visual quality, less-staining properties, scratch resistance, and/or antistatic properties at especially satisfactory levels. The optical members are exemplified by polarizing plates, retardation films, anti-reflective films, wave plates, compensation films, and brightness enhancing films constituting panels such as liquid crystal displays, organic electroluminescence (organic EL) displays, and field emission displays. However, the pressure-sensitive adhesive sheet can also be used for other applications not limited to the above ones and can be used typically for surface-protection, failure-prevention, removal of foreign matter, or masking upon production of microfabricated components such as semiconductors (semiconductor devices), circuits, printed circuit boards, masks, and lead frames.

### EXAMPLES

The present invention will be illustrated in further detail with reference to following examples, which are by no means intended to limit the scope of the invention.

### Production example 1

### Production Example of Transparent Film Substrate

Preparation of Top Coat Layer Coating Composition

In a reactor was placed 25 g of toluene, the reactor inside temperature was raised to 105° C., and a solution was continuously added dropwise into the reactor over 2 hours. The solution was a mixture of 30 g of methyl methacrylate (MMA), 10 g of n-butyl acrylate (BA), 5 g of cyclohexyl methacrylate (CHMA), and 0.2 g of azobisisobutyronitrile. After the completion of dropwise addition, the reactor inside temperature was adjusted to a temperature range of from 110° C. to 115° C., and a copolymerization reaction was performed by holding the mixture in the reactor within the temperature range for 3 hours. After a lapse of 3 hours, a mixture of 4 g of toluene and 0.1 g of azobisisobutyronitrile was added dropwise into the reactor, and the resulting mixture was held within the temperature range for one hour. The reactor inside temperature was then allowed to fall down to 90° C., the resulting mixture was combined with toluene to a NV of 5 percent by weight and yielded a solution (Binder Solution 1) containing 5 percent by weight of an acrylic polymer (Binder Polymer 1; Tg: 48° C.) serving as a binder in toluene.

Next, 2 g of Binder Solution 1 (containing 0.1 g of Binder Polymer 1) and 40 g of ethylene glycol monoethyl ether were placed in a 150-mL beaker, followed by stirring. The mixture in the beaker was further combined with 1.2 g of Electroconductive Polymer Solution 1 (aqueous solution) containing polyethylenedioxythiophene (PEDT) and polystyrenesulfonate (PSS) and having a NV of 4.0 percent by weight, 55 g of ethylene glycol monomethyl ether, 0.05 g of a polyether-modified polydimethylsiloxane leveling agent (lubricant solution) (trade name “BYK-300” supplied by Byk-Chemie GmbH, NV: 52 percent by weight), and 0.02 g of a melamine crosslinking agent (trade name “NIKALAC MW-30M” supplied by Sanwa Chemical Co., Ltd., non-volatile content: 100%); and the mixture was vigorously stirred for about 20 minutes. In this way, a top coat layer coating composition (NV: 0.2 percent by weight) was prepared. The coating composition contained 48 parts by weight of the electroconductive polymer, 26 parts by weight of the lubricant, and 20 parts by weight of the melamine crosslinking agent per 100 parts by weight of Binder Polymer 1 (acrylic polymer), in solids contents.

Top Coat Layer Formation

To a 38 μm thick by 30 cm wide by 40 cm long transparent poly(ethylene terephthalate) film (PET film) having one surface treated with corona discharge, the top coat layer coating composition was applied on the corona discharged surface using a bar coater to a dry thickness of about 10 nm. The applied composition was dried by heating at 130° C. for 2 minutes to form a top coat layer on one side of the PET film. In this way, was prepared a transparent film substrate having a PET film and, on one side thereof, a transparent top coat layer (this substrate is also referred to as “Substrate 1”).

### Production Example

### Production Example of Transparent Film Substrate

A transparent film substrate having a PET film and, on one side thereof, a transparent top coat layer (this substrate is also referred to as “Substrate 2”) was prepared by the procedure of Production Example 1, except for using Electroconductive Polymer Solution 1 in an amount of 2.5 g instead of 1.2 g; using ethylene glycol monomethyl ether in an amount of 17 g instead of 55 g; and applying the top coat layer coating solution to a dry thickness of about 20 nm.

### Production Example 3

### Production Example of Transparent Film Substrate

A transparent film substrate having a PET film and, on one side thereof, a transparent top coat layer (this substrate is also referred to as “Substrate 3”) was prepared by the procedure of Production Example 1, except for using ethylene glycol monoethyl ether in an amount of 19 g instead of 40 g; using Electroconductive Polymer Solution 1 in an amount of 0.7 g instead of 1.2 g; using no ethylene glycol monomethyl ether; and applying the top coat layer coating solution to a dry thickness of about 40 nm.

### Production Example 4

### Production Example of Transparent Film Substrate

A transparent film substrate having a PET film and, on one side thereof, a transparent top coat layer (this substrate is also referred to as “Substrate 4”) was prepared by the procedure of Production Example 3, except for using ethylene glycol monoethyl ether in an amount of 15 g instead of 19 g; and applying the top coat layer coating solution to a dry thickness of about 50 nm.

### Production Example 5

### Production Example of Transparent Film Substrate

Preparation of Top Coat Layer Coating Composition

In a reactor was placed 25 g of toluene, the reactor inside temperature was raised to 105° C., and a solution was continuously added dropwise into the reactor over 2 hours. The solution was a mixture of 32 g of methyl methacrylate (MMA), 5 g of n-butyl acrylate (BA), 0.7 g of methacrylic acid (MAA), 5 g of cyclohexyl methacrylate (CHMA), and 0.2 g of azobisisobutyronitrile. After the completion of dropwise addition, the reactor inside temperature was adjusted to a temperature range of from 110° C. to 115° C., and a copolymerization reaction was performed by holding the resulting mixture within the temperature range for 3 hours. After a lapse of 3 hours, a mixture of 4 g of toluene and 0.1 g of azobisisobutyronitrile was added dropwise into the reactor, and the resulting mixture was held within the temperature range for one hour. The reactor inside temperature was then allowed to fall down to 90° C., and the mixture was diluted with 31 g of toluene. In this way, was prepared a solution (Binder Solution 2) containing about 42 percent by weight of an acrylic polymer (Binder Polymer 2; Tg: 72° C.) serving as a binder in toluene.

Next, 5.5 g of Binder Solution 2 (containing 2.3 g of Binder Polymer 2) and 30 g of ethylene glycol monoethyl ether were placed in a 150-mL beaker, followed by stirring. The mixture in the beaker was further combined with 14 g of Electroconductive Polymer Solution 2 (aqueous solution) containing PEDT and PSS and having a NV of 1.3 percent by weight, 6 g of ethylene glycol monomethyl ether, and 0.5 g of the lubricant solution (BYK-300), and the mixture was vigorously stirred for about 30 minutes. In this way, a top coat layer coating composition was prepared. The top coat layer coating composition contained 8 parts by weight of the electroconductive polymer and 11 parts by weight of the lubricant per 100 parts by weight of Binder Polymer 2 (acrylic polymer), in solids contents. The top coat layer coating composition contained no crosslinking agent.

Top Coat Layer Formation

To a 38 μm thick by 30 cm wide by 40 cm long transparent poly(ethylene terephthalate) film (PET film) having one surface treated with corona discharge, the top coat layer coating composition was applied on the corona discharged surface using a bar coater to a dry thickness of about 610 nm. The applied composition was dried by heating at 80° C. for 2 minutes to form a top coat layer. In this way, a transparent film substrate having a PET film and, on one side thereof, a transparent top coat layer (this substrate is also referred to as “Substrate 5”) was prepared.

### Production Example 6

### Production Example of Transparent Film Substrate

Preparation of Top Coat Layer Coating Composition

In a reactor was placed 25 g of toluene, the reactor inside temperature was raised to 105° C., and a solution was continuously added dropwise into the reactor over 2 hours. The solution was a mixture of 30 g of methyl methacrylate (MMA), 10 g of n-butyl acrylate (BA), 5 g of cyclohexyl methacrylate (CHMA), 5 g of hydroxyethyl methacrylate (HEMA), and 0.2 g of azobisisobutyronitrile. After the completion of dropwise addition, the reactor inside temperature was adjusted to a temperature range of from 110° C. to 115° C., and a copolymerization reaction was performed by holding the mixture within the temperature range for 3 hours. After a lapse of 3 hours, a mixture of 4 g of toluene and 0.1 g of azobisisobutyronitrile was added dropwise into the reactor, and the resulting mixture was held within the temperature range for one hour. The reactor inside temperature was then allowed to fall down to 90° C., and the mixture was diluted with toluene. In this way, a solution (Binder Solution 3) containing about 5 percent by weight of an acrylic polymer (Binder Polymer 3; Tg: 49° C.) serving as a binder in toluene was prepared.

Next, 2 g of Binder Solution 3 (containing 0.1 g of Binder Polymer 3) and 40 g of ethylene glycol monoethyl ether were placed in a 150-mL beaker, followed by stirring. The mixture in the beaker was further combined with 1.2 g of Electroconductive Polymer Solution 1 (aqueous solution) containing polyethylenedioxythiophene (PEDT) and polystyrenesulfonate (PSS) and having a NV of 4.0 percent by weight, 55 g of ethylene glycol monomethyl ether, 0.05 g of a polyether-modified polydimethylsiloxane leveling agent (lubricant solution) (trade name “BYK-300” supplied by Byk-Chemie GmbH, NV: 52 percent by weight), and 0.02 g of a melamine crosslinking agent (trade name “NIKALAC MW-30M” supplied by Sanwa Chemical Co., Ltd.), and the mixture was vigorously stirred for about 20 minutes. In this way, a top coat layer coating composition (NV: 0.2 percent by weight) was prepared. This contained 48 parts by weight of the electroconductive polymer, 26 parts by weight of the lubricant, and 20 parts by weight of the melamine crosslinking agent per 100 parts by weight of Binder Polymer 3 (acrylic polymer), in solids contents.

Top Coat Layer Formation

To a 38 μm thick by 30 cm wide by 40 cm long transparent poly(ethylene terephthalate) film (PET film) having one surface treated with corona discharge, the top coat layer coating composition was applied on the corona discharged surface using a bar coater to a dry thickness of about 8 nm. The applied composition was dried by heating at 130° C. for 2 minutes to form a top coat layer on one side of the PET film. In this manner a transparent film substrate having a PET film and, on one side thereof, a transparent top coat layer (this substrate is also referred to as “Substrate 6”) was prepared.

Table 1 gives the top coat layer formulations (compositions) of the above-prepared transparent film substrates (Substrates 1 to 6), and evaluation results of these transparent film substrates as determined by evaluation procedures mentioned below.

### Production Example 7

### Production Example of Water-Dispersible Acrylic Pressure-Sensitive Composition

Preparation of Acrylic Emulsion Polymer

In a vessel were placed 90 parts by weight of water and, as indicated in Table 2, 94 parts by weight of 2-ethylhexyl acrylate (2EHA), 2 parts by weight of methyl methacrylate (MMA), 4 parts by weight of acrylic acid (AA), and 6 parts by weight of a nonionic-anionic reactive emulsifier (trade name “AQUALON HS-10” supplied by Dai-ichi Kogyo Seiyaku Co., Ltd.), the mixture was stirred by a homomixer and yielded a monomer emulsion.

Next, 50 parts by weight of water, 0.01 part by weight of a polymerization initiator (ammonium persulfate), and the above-prepared monomer emulsion in an amount corresponding to 10 percent by weight of the prepared whole quantity were placed in a reactor equipped with a condenser, a nitrogen inlet tube, a thermometer, and a stirrer, and the mixture was subjected to emulsion polymerization with stirring at 75° C. for one hour. The mixture was combined with 0.07 part by weight of the polymerization initiator (ammonium persulfate) and, with stirring, further combined with the entire residual monomer emulsion (in an amount corresponding to 90 percent by weight) added over 3 hours, followed by a reaction at 75° C. for 3 hours. Next, this was cooled down to 30° C., adjusted to a pH of 8 with a 10 percent by weight concentration aqueous ammonia, and yielded an acrylic emulsion polymer water dispersion.

Preparation of Water-Dispersible Acrylic Pressure-Sensitive Composition

The above-prepared acrylic emulsion polymer water dispersion was combined with an epoxy crosslinking agent [trade name “TETRAD-C” supplied by MITSUBISHI GAS CHEMICAL COMPANY, INC., 1,3-bis(N,N-diglycidylaminomethyl)cyclohexane, epoxy equivalent: 110, number of functional groups: 4] as a water-insoluble crosslinking agent in an amount of 3 parts by weight per 100 parts by weight of the acrylic emulsion polymer (solids content), the mixture was stirred with a stirrer at 23° C. and 300 rpm for 10 minutes, and yielded a water-dispersible acrylic pressure-sensitive adhesive composition (hereinafter also referred to as Pressure-sensitive Adhesive 1, i.e., “PSA 1”).

### Production Example 8

### Production Example of Water-Dispersible Acrylic Pressure-Sensitive Composition

A water-dispersible acrylic pressure-sensitive adhesive composition (hereinafter also referred to as “PSA 2”) was prepared by the procedure of Production Example 7, except for using 92 parts by weight of 2-ethylhexyl acrylate (2EHA), 4 parts by weight of methyl methacrylate (MMA), and 4 parts by weight of acrylic acid (AA) as constitutive monomers to form an acrylic emulsion polymer; and using the reactive emulsifier “AQUALON HS-10” in an amount of 3 parts by weight, as indicated in Table 2.

### Production Example 9

### Production Example of Water-Dispersible Acrylic Pressure-Sensitive Composition

A water-dispersible acrylic pressure-sensitive adhesive composition (hereinafter also referred to as “PSA 3”) was prepared by the procedure of Production Example 8, except for using 88 parts by weight of 2-ethylhexyl acrylate (2EHA), 8 parts by weight of methyl methacrylate (MMA), and 4 parts by weight of acrylic acid (AA) as constitutive monomers to form an acrylic emulsion polymer, as indicated in Table 2.

### Production Example 10

### Production Example of Water-Dispersible Acrylic Pressure-Sensitive Composition

A water-dispersible acrylic pressure-sensitive adhesive composition (hereinafter also referred to as “PSA 4”) was prepared by the procedure of Production Example 7, except for using 92 parts by weight of 2-ethylhexyl acrylate (2EHA), 4 parts by weight of vinyl acetate (Vac), and 4 parts by weight of acrylic acid (AA) as constitutive monomers to form an acrylic emulsion polymer; and using 4.5 parts by weight of “ADEKA REASOAP SE-10N” as a reactive emulsifier instead of “AQUALON HS-10”, as indicated in Table 2.

### Production Example 11

### Production Example of Water-Dispersible Acrylic Pressure-Sensitive Composition

A water-dispersible acrylic pressure-sensitive adhesive composition (hereinafter also referred to as “PSA 5”) was prepared by the procedure of Production Example 7, except for using 92 parts by weight of 2-ethylhexyl acrylate (2EHA), 4 parts by weight of diethylacrylamide (DEAA), and 4 parts by weight of acrylic acid (AA) as constitutive monomers to form an acrylic emulsion polymer; using 3 parts by weight of “ADEKA REASOAP SE-10N” as a reactive emulsifier instead of “AQUALON HS-10”; and using the water-insoluble crosslinking agent “TETRAD-C” in an amount of 4 parts by weight, as indicated in Table 2.

### Production Example 12

### Production Example of Water-Dispersible Acrylic Pressure-Sensitive Composition

A water-dispersible acrylic pressure-sensitive adhesive composition (hereinafter also referred to as “PSA 6”) was prepared by the procedure of Production Example 8, except for using 3 parts by weight of “TETRAD-X” as a water-insoluble crosslinking agent instead of “TETRAD-C”, as indicated in Table 2.

### Production Example 13

### Production Example of Water-Dispersible Acrylic Pressure-Sensitive Composition

A water-dispersible acrylic pressure-sensitive adhesive composition (hereinafter also referred to as “PSA 7”) was prepared by the procedure of Production Example 7, except for using 4.5 parts by weight of a nonreactive emulsifier “LA-16” instead of the reactive emulsifier “AQUALON HS-10”, as indicated in Table 2.

### Production Example 14

### Production Example of Water-Dispersible Acrylic Pressure-Sensitive Composition

A water-dispersible acrylic pressure-sensitive adhesive composition (hereinafter also referred to as “PSA 8”) was prepared by the procedure of Production Example 10, except for using 3 parts by weight of a nonreactive emulsifier “LA-16” instead of the reactive emulsifier “ADEKA REASOAP SE-10N”, as indicated in Table 2.

Table 2 gives formulations of the above-prepared water-dispersible acrylic pressure-sensitive adhesive compositions (PSAs 1 to 8).

### Example 1

As indicated in Table 3, the above-obtained water-dispersible acrylic pressure-sensitive adhesive composition (PSA 1) was applied to a surface of the prepared transparent film substrate (Substrate 1) opposite to the top coat layer using an applicator (TESTER SANGYO CO., LTD.) to a dry thickness of 15 μm. The applied composition was dried in an oven with internal air circulation at 120° C. for 2 minutes. To a PET film (“MRF38” supplied by Mitsubishi Plastics, Inc.) having a surface treated with a silicone, the dried pressure-sensitive adhesive layer surface was laminated on the silicone-treated surface, aged at 50° C. for 3 days, and yielded a pressure-sensitive adhesive sheet.

### Examples 2 To 9 and Comparative Examples 1 to 5

Pressure-sensitive adhesive sheets were prepared by the procedure of Example 1, except for using a water-dispersible acrylic pressure-sensitive adhesive composition and/or a transparent film substrate of a different type, as indicated in Table 3. A product under the trade name of “Diafoil T100G” (supplied by Mitsubishi Chemical Corporation) used as the substrate in Comparative Example 3 was a PET film having an antistatic layer on one side thereof (antistatic-treated PET film). The antistatic layer contained, as an antistatic agent, a compound having an ammonium base.

Evaluation

The above-prepared transparent film substrates, and the pressure-sensitive adhesive sheets obtained in Examples and Comparative Examples were subjected to evaluations by measurement methods or evaluation methods mentioned later. Of the acrylic emulsion polymers, the solvent-insoluble content and the weight-average molecular weight of the solvent-soluble fraction were measured by the aforementioned measurement methods.

Evaluation results are given in Tables 1 to 3.

(1) Top Coat Layer Thickness (Average Thickness and Thickness Variation)

The top coat layer thickness was measured by observing a cross section of each of the transparent film substrates prepared in Production Examples with a transmission electron microscope (TEM).

Separately, peak intensities of sulfur atom (derived from PEDT and PSS contained in the top coat layer) were measured on the top coat layer surface of each transparent film substrate using an X-ray fluorescence analyzer (XRF analyzer, Model “ZSX-100e” supplied by Rigaku Corporation). The X-ray fluorescence analysis was performed under conditions as follows.

X-Ray Fluorescence Analysis

Instrument: XRF analyzer, Model “ZSX-100e” supplied by Rigaku Corporation

X-ray source: vertical Rh tube

Analysis range: within a circle of 30 mm diameter

Detected X-ray: S-Kα

Dispersive crystal: Ge crystal

Output: 50 kV, 70 mA

Based on the top coat layer thickness (the measured value) obtained by TEM observation and the data of the X-ray fluorescence analysis, a calibration curve was plotted to derive the top coat layer thickness from peak intensities observed in the X-ray fluorescence analysis.

The top coat layer thickness of each transparent film substrate was measured using the calibration curve. Specifically, X-ray fluorescence analysis was performed starting from one end of the width through the other end at 1/6, 2/6, 3/6, 4/6, and 5/6 the width along a straight line across the width (in a direction perpendicular to the bar coater's moving direction) of the area bearing the top coat layer. Based on the obtained data (sulfur atom X-ray intensities (kcps)) together with the top coat layer formulation (the contents of PEDT and PSS) and the calibration curve, were determined the thicknesses of the top coat layer at the respective five measurement points. The average thickness Dₐᵥₑ was determined by averaging the top coat layer thickness values of the five measurement points. The thickness variation ΔD was calculated by substituting the average thickness Dₐᵥₑ, the maximum value Dₘₐₓ and the minimum value Dₘᵢₙ of the top coat layer thickness values at the five measurement points into an equation as follows:

ΔD=(Dₘₐₓ−Dₘᵢₙ)/Dₐᵥₑ×100(%).

(2) X-Ray Intensity Variation in Top Coat Layer Surface

The average X-ray intensity Iₐᵥₑ was determined by averaging the sulfur atom X-ray intensities (kcps) obtained at the respective locations (the five measurement points) by the X-ray fluorescence analysis. In addition, the X-ray intensity variation ΔI was calculated by substituting the average X-ray intensity Iₐᵥₑ, the maximum value Iₘₐₓ and the minimum value Iₘᵢₙ of the X-ray intensities at the respective locations (the five measurement points) into an equation as follows:

ΔI=(Iₘₐₓ−Iₘᵢₙ)/Iₐᵥₑ×100(%).

(3) Transparent Film Substrate Appearance

The backside (top coat layer side surface) of each of the transparent film substrates (Substrates 1 to 6) was visually observed in a room (bright room) having a window admitting the outside light. The observation was performed beside the window where no direct sunlight was got during the daytime on a sunny day. Based on the observed results, the appearance of each transparent film substrate was evaluated according to criteria as follows:

Good (good appearance): neither unevenness nor streaks were observed.

Poor (poor appearance): unevenness and/or streaks were observed.

(4) Top Coat Layer Surface Resistivity

The surface resistance Rs of the top coat layer side surface of each of the above-prepared transparent film substrates (Substrates 1 to 6) was measured according to JIS K6911 using an insulation resistance tester (trade name “Hiresta-up MCP-HT450” supplied by Mitsubishi Chemical Analytech Co., Ltd.) at an ambient temperature of 23° C. and relative humidity of 55%. The applied voltage was 100 V, and the surface resistance Rs was read 60 seconds into the measurement. Based on the results, the surface resistivity was calculated according to an equation as follows:

ρs=Rs×E/V×π(D+d)/(D−d)

wherein ρs represents the surface resistivity (Ω/square), Rs represents the surface resistance (Ω); E represents the applied voltage (V); V represents the measured voltage (V); D represents the inner diameter (cm) of the ring surface electrode; and d represents the outer diameter (cm) of the inner circle of the surface electrode.

(5) Top Coat Layer Surface Scratch Resistance

A sample of 10 cm² (10 cm wide by 10 cm long) was cut out from each of the above-prepared transparent film substrates (Substrates 1 to 6). An examiner scratched the backside (top coat layer side surface) of the sample by fingernails in a room (bright room) having a window admitting outside light, and the scratch resistance was evaluated by the presence of scratches caused by the fingernails. Specifically, the backside of the sample after being scratched by the fingernails was observed with an optical microscope. A sample where debris scraped off from the top coat layer was observed was evaluated as “Poor” (poor scratch resistance); whereas a sample where no debris was observed was evaluated as “Good” (good scratch resistance).

(6) Resistance to Adhesive Strength Increase (Initial Adhesive Strength and Adhesive Strength after One-Week Application/Storage at 40° C.)

Initial Adhesive Strength

The pressure-sensitive adhesive layer side surface of each of the pressure-sensitive adhesive sheets obtained in Examples and Comparative Examples (sample size: 25 mm wide by 100 mm long) was laminated onto a polarizing plate using a laminator [compact laminator supplied by TESTER SANGYO CO., LTD.] at 0.25 MPa and 0.3 m/min. The polarizing plate was made from triacetyl cellulose (TAC) and had an arithmetic mean surface roughness (Ra) of about 21 nm in the machine direction (MD), about 31 nm in the transverse direction (TD), 119- and about 26 nm on an average of the machine direction (MD) and the transverse direction (TD).

The laminated sample including the pressure-sensitive adhesive sheet and the polarizing plate was left stand at an ambient temperature of 23° C. and relative humidity of 50% for 20 minutes, subjected to a 180-degree peel test under conditions mentioned below, the adhesive strength (N/25 mm) of the pressure-sensitive adhesive sheet to the polarizing plate was measured, and this was defined as an “initial adhesive strength.”

Adhesive Strength after One-Week Application/Storage at 40° C.

The pressure-sensitive adhesive layer side surface of each of the pressure-sensitive adhesive sheets obtained in Examples and Comparative Examples (sample size: 25 mm wide by 100 mm long) was laminated onto a polarizing plate using a laminator [compact laminator supplied by TESTER SANGYO CO., LTD.] at 0.25 MPa and 0.3 m/min. The polarizing plate was made from triacetyl cellulose (TAC) and had an arithmetic mean surface roughness (Ra) of about 21 nm in the machine direction (MD), about 31 nm in the transverse direction (TD), and about 26 nm on an average of the machine direction (MD) and the transverse direction (TD).

The laminated sample including the pressure-sensitive adhesive sheet and the polarizing plate was stored at an ambient temperature of 40° C. for one week, left stand at an ambient temperature of 23° C. and relative humidity of 50% for 2 hours, subjected to a 180-degree peel test under conditions mentioned below, the adhesive strength (N/25 mm) of the pressure-sensitive adhesive sheet to the polarizing plate was measured, and this was defined as an “adhesive strength after one-week application/storage at 40° C.”

The 180-degree peel test was performed using a tensile tester at an ambient temperature of 23° C. and relative humidity of 50% and at a tensile speed of 30 m/min.

A sample having a difference between the initial adhesive strength and the adhesive strength after one-week application/storage at 40° C. [(adhesive strength after one-week application/storage at 40° C.)−(initial adhesive strength)] of less than 0.5 N/25 mm could be determined as being satisfactorily resistant to adhesive strength increase.

(7) Clouding (Clouding Resistance) of Pressure-Sensitive Adhesive Sheet Upon High-Humidity Storage

Each of the pressure-sensitive adhesive sheets obtained in Examples and Comparative Examples was left stand at an ambient temperature of 50° C. and relative humidity of 95% for 24 hours (stored under humid conditions), the haze of which was then measured with “DIGITAL HAZEMETER NDH-20D” supplied by Nippon Denshoku Industries Co., Ltd. This was defined as a “haze after storage under humid conditions.” The measurement was performed within 3 minutes after the sample was retrieved from the environment at a temperature of 50° C. and relative humidity of 95%. As a comparison, the haze of the sample before storage under humid conditions was also measured and defined as a “haze before storage under humid conditions.”

(8) Appearance (Presence/Absence of Dimples and/or Gelled Substance) of Acrylic Pressure-Sensitive Adhesive Layer

The acrylic pressure-sensitive adhesive layer surface of each of the pressure-sensitive adhesive sheets obtained in Examples and Comparative Examples was visually observed. Defects (dimples and/or gelled substance) in an observation area of 10 cm long by 10 cm wide were counted, and the appearance of the acrylic pressure-sensitive adhesive layer was evaluated according to criteria as follows:

Good appearance (Good) of the acrylic pressure-sensitive adhesive layer: the number of defects was from 0 to 100

Poor appearance (Poor) of the acrylic pressure-sensitive adhesive layer: the number of defects was 101 or more.

(9) Pressure-Sensitive Adhesive Sheet Appearance

The appearance of each of the pressure-sensitive adhesive sheets obtained in Examples and Comparative Examples was evaluated based on the results of evaluation (3) on the appearance of the transparent film substrate and the results of evaluation (8) on the appearance of the acrylic pressure-sensitive adhesive layer, according to criteria as follows:

Poor appearance (Poor) of the pressure-sensitive adhesive sheet: the transparent film substrate had a poor appearance;

Good appearance (Good) of the pressure-sensitive adhesive sheet: the transparent film substrate had a good appearance, and the number of defects in the acrylic pressure-sensitive adhesive layer surface was 101 or more;

Very good appearance (VG) of the pressure-sensitive adhesive sheet: the transparent film substrate had a good appearance, and the number of defects in the acrylic pressure-sensitive adhesive layer surface was from 0 to 100.

(10) Elongation at Breaking Point of Acrylic Pressure-Sensitive Adhesive Layer (after Crosslinking)

To a PET film (trade name “MRF38” supplied by Mitsubishi Plastics, Inc.) having a surface treated with a silicone, was applied each of the above-prepared water-dispersible acrylic pressure-sensitive adhesive compositions (PSAs 1 to 8) on the silicone-treated surface to a dry thickness of 50 μm, then dried in an oven with internal air circulation at 120° C. for 2 minutes, aged at 50° C. for 3 days, and yielded a 50-μm thick acrylic pressure-sensitive adhesive layer.

Elongation at Breaking Point Measurement

Next, the acrylic pressure-sensitive adhesive layer was rounded and yielded a cylindrical sample (50 mm in length and 1 mm² in sectional area (base area)). The elongation at breaking point was measured using a tensile tester at an ambient temperature of 23° C. and relative humidity of 50%. While setting chucks so as to give an initial measurement length (initial chuck-to-chuck distance) of 10 mm, the tensile test was performed at a tensile speed of 50 mm/min, and the elongation at the time when the sample breaks [elongation at breaking point] was measured.

The “elongation at breaking point” refers to an elongation at the time when the test piece (cylindrical sample of the acrylic pressure-sensitive adhesive layer) breaks, and is calculated according to an equation as follows:

[Elongation at breaking point](%)=[(Test piece length at break(chuck-to-chuck distance at break))−(Initial length (10 mm))]÷(Initial length (10 mm))×100

(11) Solvent-Insoluble Content of Acrylic Pressure-Sensitive Adhesive Layer (after Crosslinking)

About 0.1 g of the acrylic pressure-sensitive adhesive layer was sampled from each of the pressure-sensitive adhesive sheets obtained in Examples and Comparative Examples, covered with a porous tetrafluoroethylene sheet (trade name “NTF1122” supplied by Nitto Denko Corporation) having an average pore size of 0.2 μm, tied with a kite string, the weight of the resulting article was measured, and this was defined as a “weight before immersion.” The weight before immersion is the total weight of the acrylic pressure-sensitive adhesive layer (the sampled one), the tetrafluoroethylene sheet, and the kite string. Separately, the total weight of the tetrafluoroethylene sheet and the kite string was measured, and this was defined as a “tare weight.”

Next, the article including the acrylic pressure-sensitive adhesive layer covered by the tetrafluoroethylene sheet and tied with the kite string (this article is also referred to as a “sample”) was placed in ethyl acetate filled in a 50-ml vessel and left stand at 23° C. for 7 days. The sample (after ethyl acetate treatment) was then retrieved from the vessel, transferred into an aluminum cup, dried in a drying oven at 130° C. for 2 hours to remove ethyl acetate, the weight of the dried article was measured, and this was defined as a “weight after immersion.”

Based on these data, the solvent-insoluble content was calculated according to an equation as follows:

Solvent-insoluble content(percent by weight)=(d−e)/(f−e)×100

wherein “d” represents the weight after immersion; “e” represents the tare weight; and “f” represents the weight before immersion.

TABLE 1

| | | Sub- | | Sub- | | | |
|---|---|---|---|---|---|---|---|
| | | strate 1 | Substrate 2 | strate 3 | Substrate 4 | Substrate 5 | Substrate 6 |
| Top coat layer | Binder Solution 1 (g) | 2 | 2 | 2 | 2 | — | — |
| coating | Binder Solution 2 (g) | — | — | — | — | 5.5 | — |
| composition | Binder Solution 3 (g) | — | — | — | — | — | 2 |
| formulation | Ethylene glycol monoethyl ether (g) | 40 | 40 | 19 | 15 | 30 | 40 |
| | Electroconductive Polymer Solution 1 (g) | 1.2 | 2.5 | 0.7 | 0.7 | — | 1.2 |
| | Electroconductive Polymer Solution 2 (g) | — | — | — | — | 14 | — |
| | Ethylene glycol monomethyl ether (g) | 55 | 17 | — | — | 6 | 55 |
| | Lubricant solution (g) | 0.05 | 0.05 | 0.05 | 0.05 | 0.5 | 0.05 |
| | Melamine crosslinking agent (g) | 0.02 | 0.02 | 0.02 | 0.02 | — | 0.02 |
| NV (weight %) of Top coat layer coating composition | | 0.2 | 0.4 | 0.8 | 1.0 | 4.9 | 0.2 |
| Top coat layer | Binder Polymer 1 (part by weight) [copolymerization | 100 | 100 | 100 | 100 | — | — |
| | composition: MMA/BA/CHMA = 30/10/5] | | | | | | |
| | Binder Polymer 2 (part by weight) [copolymerization | — | — | — | — | 100 | — |
| | composition: MMA/BA/MAA/CHMA = 32/5/0.7/5] | | | | | | |
| | Binder Polymer 3 (part by weight) [copolymerization | — | — | — | — | — | 100 |
| | composition: MMA/BA/CHMA/HEMA = 30/10/5/5] | | | | | | |
| | Polythiophene and PSS (part by weight) | 48 | 100 | 28 | 28 | 8 | 48 |
| | Lubricant (part by weight) | 26 | 26 | 26 | 26 | 11 | 26 |
| | Melamine crosslinking agent (part by weight) | 20 | 20 | 20 | 20 | — | 20 |
| Evaluation data of | Average thickness Dₐᵥₑ (nm) of top coat layer | 7.8 | 18.9 | 34.6 | 51.2 | 612.4 | 8.2 |
| transparent film | Thickness variation ΔD (%) of top coat layer | 15.8 | 34.4 | 12.5 | 34.4 | 52.7 | 15.5 |
| substrate | Average X-ray intensity Iₐᵥₑ (kcps) of top coat layer | 0.43 | 2.07 | 1.13 | 1.68 | 5.35 | 0.45 |
| | X-ray variation ΔI (%) of top coat layer | 15.8 | 34.4 | 12.5 | 34.4 | 52.7 | 15.5 |

TABLE 2

| | | | | PSA 1 | PSA 2 | PSA 3 | PSA 4 | PSA 5 | PSA 6 | PSA 7 | PSA 8 |
|---|---|---|---|---|---|---|---|---|---|---|---|
| Acrylic | Constitutive | (Meth)acrylic alkyl | 2EHA | 94 | 92 | 88 | 92 | 92 | 92 | 94 | 92 |
| emulsion | monomer (part | ester (A) | | | | | | | | | |
| polymer | by weight) | Monomer (C) | MMA | 2 | 4 | 8 | — | — | 4 | 2 | — |
| | | | Vac | — | — | — | 4 | — | — | — | 4 |
| | | | DEAA | — | — | — | — | 4 | — | — | — |
| | | Carboxyl-containing | AA | 4 | 4 | 4 | 4 | 4 | 4 | 4 | 4 |
| | | unsaturated | | | | | | | | | |
| | | monomer (B) | | | | | | | | | |

| | | | | | | | | | |
|---|---|---|---|---|---|---|---|---|---|
| Polymerization | Ammonium persulfate | 0.08 | 0.08 | 0.08 | 0.08 | 0.08 | 0.08 | 0.08 | 0.08 |
| initiator (part | | | | | | | | | |
| by weight) | | | | | | | | | |
| Emulsifier (part | HS-10 | 6 | 3 | 3 | — | — | 3 | — | — |
| by weight) | SE-10N | — | — | — | 4.5 | 3 | — | — | — |
| | LA-16 | — | — | — | — | — | — | 4.5 | 3 |

| | Solvent-insoluble content (weight %) | | 81 | 85 | 86 | 82 | 81 | 85 | 75 | 81 |
|---|---|---|---|---|---|---|---|---|---|---|
| | Weight-average molecular weight of solvent- | | 8 × 10⁴ | 10 × 10⁴ | 10 × 10⁴ | 7 × 10⁴ | 8 × 10⁴ | 10 × 10⁴ | 10 × 10⁴ | 11 × 10⁴ |
| | soluble fraction | | | | | | | | | |
| Water- | Acrylic emulsion polymer (part by weight) | | 100 | 100 | 100 | 100 | 100 | 100 | 100 | 100 |
| dispersible | Water-insoluble crosslinking | TETRAD C | 3 | 3 | 3 | 3 | 4 | — | 3 | 3 |
| acrylic | agent (part by weight) | TETRAD X | — | — | — | — | — | 3 | — | — |

| | | | | | | | | | |
|---|---|---|---|---|---|---|---|---|---|
| pressure- | Ratio (molar ratio) of [number of moles of | 0.5 | 0.5 | 0.5 | 0.5 | 0.7 | 0.5 | 0.5 | 0.5 |
| sensitive | epoxy group (glycidylamino group)] to | | | | | | | | |
| composition | [number of moles of carboxyl group] | | | | | | | | |

TABLE 3

| | | | Example 1 | Example 2 | Example 3 | Example 4 | Example 5 | Example 6 | Example 7 |
|---|---|---|---|---|---|---|---|---|---|
| Sheet structure | Water-dispersible acrylic | | PSA 1 | PSA 2 | PSA 3 | PSA 4 | PSA 5 | PSA 6 | PSA 1 |
| | pressure-sensitive composition | | | | | | | | |
| | Transparent film substrate | | Substrate 1 | Substrate 1 | Substrate 1 | Substrate 1 | Substrate 1 | Substrate 1 | Substrate 2 |
| Evaluation | Solvent-insoluble content | | 97 | 97 | 97 | 97 | 98 | 97 | 97 |
| result | (weight %) of acrylic pressure- | | | | | | | | |
| | sensitive adhesive layer (after | | | | | | | | |
| | crosslinking) | | | | | | | | |
| | Elongation at breaking point (%) | | 105 | 103 | 91 | 112 | 104 | 98 | 105 |
| | of acrylic pressure-sensitive | | | | | | | | |
| | adhesive layer | | | | | | | | |
| | Resistance | Initial adhesive | 0.6 | 0.5 | 0.5 | 0.9 | 1.0 | 0.6 | 0.6 |
| | to | strength (N/25 mm) | | | | | | | |
| | adhesive | Adhesive strength | 0.6 | 0.6 | 0.5 | 0.9 | 1.1 | 0.6 | 0.6 |
| | strength | (N/25 mm) after | | | | | | | |
| | increase | one-week | | | | | | | |
| | | application/storage | | | | | | | |
| | | at 40° C. | | | | | | | |
| | Clouding | Haze (%) before | 2.4 | 2.4 | 2.4 | 2.4 | 2.4 | 2.4 | 2.4 |
| | resistance | storage under | | | | | | | |
| | | humid conditions | | | | | | | |
| | | Haze (%) after | 2.5 | 2.5 | 2.4 | 2.4 | 2.5 | 2.5 | 2.5 |
| | | storage under | | | | | | | |
| | | humid conditions | | | | | | | |
| | Appearance of acrylic pressure- | | Good | Good | Good | Good | Good | Good | Good |
| | sensitive adhesive layer | | | | | | | | |
| | Appearance of transparent film | | Good | Good | Good | Good | Good | Good | Good |
| | substrate | | | | | | | | |
| | Appearance of pressure- | | VG | VG | VG | VG | VG | VG | VG |
| | sensitive adhesive sheet | | | | | | | | |
| | Surface resistivity (Ω/square) | | 4.3 × 10⁹ | 4.3 × 10⁹ | 4.3 × 10⁹ | 4.3 × 10⁹ | 4.3 × 10⁹ | 4.3 × 10⁹ | 3.3 × 10⁹ |
| | Scratch resistance | | Good | Good | Good | Good | Good | Good | Good |
| | | | Example 8 | Example 9 | Com. Ex. 1 | Com. Ex. 2 | Com. Ex. 3 | Com. Ex. 4 | Com. Ex. 5 |
| Sheet structure | Water-dispersible acrylic | | PSA 1 | PSA 1 | PSA 7 | PSA 8 | PSA 1 | PSA 1 | PSA 1 |
| | pressure-sensitive composition | | | | | | | | |
| | Transparent film substrate | | Substrate 3 | Substrate 6 | Substrate 1 | Substrate 1 | T100G | Substrate 4 | Substrate 5 |
| Evaluation | Solvent-insoluble content | | 97 | 97 | 90 | 97 | 97 | 97 | 97 |
| result | (weight %) of acrylic pressure- | | | | | | | | |
| | sensitive adhesive layer (after | | | | | | | | |
| | crosslinking) | | | | | | | | |
| | Elongation at breaking point (%) | | 105 | 105 | 102 | 122 | 105 | 105 | 105 |
| | of acrylic pressure-sensitive | | | | | | | | |
| | adhesive layer | | | | | | | | |
| | Resistance | Initial adhesive | 0.6 | 0.6 | 0.5 | 0.7 | 0.6 | 0.6 | 0.6 |
| | to | strength (N/25 mm) | | | | | | | |
| | adhesive | Adhesive strength | 0.6 | 0.6 | 0.5 | 0.7 | 0.6 | 0.6 | 0.6 |
| | strength | (N/25 mm) after | | | | | | | |
| | increase | one-week | | | | | | | |
| | | application/storage | | | | | | | |
| | | at 40° C. | | | | | | | |
| | Clouding | Haze (%) before | 2.4 | 2.4 | 2.4 | 2.4 | 2.1 | —(*1) | —(*1) |
| | resistance | storage under | | | | | | | |
| | | humid conditions | | | | | | | |
| | | Haze (%) after | 2.5 | 2.5 | 8.2 | 7.8 | 3.7 | —(*1) | —(*1) |
| | | storage under | | | | | | | |
| | | humid conditions | | | | | | | |

| | | | | | | | |
|---|---|---|---|---|---|---|---|
| Appearance of acrylic pressure- | Good | Good | Good | Good | Good | Good | Good |
| sensitive adhesive layer | | | | | | | |
| Appearance of transparent film | Good | Good | Good | Good | Good | Poor | Poor |
| substrate | | | | | | | |
| Appearance of pressure- | VG | VG | VG | VG | VG | Poor | Poor |
| sensitive adhesive sheet | | | | | | | |
| Surface resistivity (Ω/square) | 4.5 × 10⁹ | 4.7 × 10⁹ | 4.3 × 10⁹ | 4.3 × 10⁹ | 2.1 × 10⁹ | 8.9 × 10⁹ | 2.1 × 10⁷ |
| Scratch resistance | Good | Good | Good | Good | Poor | Good | Poor |

(*1): No measurement was performed due to poor appearance of the substrate.

Abbreviations used in Tables 2 and 3 are as follows:

Constitutive Monomers
2EHA: 2-ethylhexyl acrylate
MMA: methyl methacrylate
Vac: vinyl acetate
DEAA: diethylacrylamide
AA: acrylic acid

Emulsifier
HS-10: trade name “AQUALON HS-10” (nonionic-anionic reactive emulsifier) supplied by Dai-ichi Kogyo Seiyaku Co., Ltd.
SE-10N: trade name “ADEKA REASOAP SE-10N” (nonionic-anionic reactive emulsifier) supplied by ADEKA CORPORATION
LA-16: trade name “HITENOL LA-16” (nonionic-anionic nonreactive emulsifier) supplied by Dai-ichi Kogyo Seiyaku Co., Ltd.

Crosslinking Agent
TETRAD C: trade name “TETRAD-C” (1,3-bis(N,N-diglycidylaminomethyl)cyclohexane, epoxy equivalent: 110, number of functional groups: 4) supplied by MITSUBISHI GAS CHEMICAL COMPANY, INC.
TETRAD X: trade name “TETRAD-X” (1,3-bis(N,N-diglycidylaminomethyl)benzene, epoxy equivalent: 100, number of functional groups: 4) supplied by MITSUBISHI GAS CHEMICAL COMPANY, INC.

Substrate (Transparent Film Substrate)
T100G: antistatic-treated PET film, trade name “Diafoil T100G” (supplied by Mitsubishi Chemical Corporation)

As demonstrated by data in Table 3, pressure-sensitive adhesive sheets according to Examples satisfying conditions specified in the present invention were not clouded when stored under humid conditions.

By contrast, pressure-sensitive adhesive sheets according to Comparative Examples (Comparative Examples 1 and 2) employing a nonreactive emulsifier instead of a reactive emulsifier each had a significantly increased haze after storage under humid conditions, demonstrating that these pressure-sensitive adhesive sheets were clouded upon storage under humid conditions. Pressure-sensitive adhesive sheets according to Comparative Examples (Comparative Examples 4 and 5) employing a top coat layer in a substrate with an average thickness and/or a thickness variation not satisfying the conditions specified in the present invention had a poor appearance. Of these, the pressure-sensitive adhesive sheet according to Comparative Example 5, whose top coat layer contained no melamine crosslinking agent, also had poor scratch resistance. A pressure-sensitive adhesive sheet (Comparative Example 3), whose substrate employed an antistatic layer not being a top coat layer including a polythiophene, an acrylic resin, and a melamine crosslinking agent, had an increase haze after storage under humid conditions and also exhibited poor scratch resistance.

### INDUSTRIAL APPLICABILITY

The pressure-sensitive adhesive sheets according to embodiments of the present invention are used in applications where they will be removed. The pressure-sensitive adhesive sheets are particularly preferably used for the surface protection of optical members (e.g., optical plastics, optical glass, and optical films) typically as surface-protecting films for optical members. The optical members are exemplified by polarizing plates, retardation films, anti-reflective films, wave plates, compensation films, and brightness enhancing films to constitute panels such as liquid crystal displays, organic electroluminescence (organic EL) displays, and field emission displays. In addition, the pressure-sensitive adhesive sheets according to the present invention can also be used typically for surface-protection, failure-prevention, removal of foreign matter, or masking upon production of microfabricated components such as semiconductors (semiconductor devices), circuits, printed circuit boards, masks, and lead frames.

1. A pressure-sensitive adhesive sheet comprising:
a transparent film substrate; and an acrylic pressure-sensitive adhesive layer present on or over at least one side of the transparent film substrate,
wherein:
the transparent film substrate comprises a base layer comprising a resinous material, and a top coat layer present on or above a first face of the base layer;
the top coat layer comprises a polythiophene, an acrylic resin, and a melamine crosslinking agent and has an average thickness Dₐᵥₑ of from 2 to 50 nm and a thickness variation ΔD of 40% or less;
the acrylic pressure-sensitive adhesive layer is formed from a water-dispersible removable acrylic pressure-sensitive adhesive composition comprising an acrylic emulsion polymer;
the acrylic emulsion polymer is derived from constitutive monomers comprising a (meth)acrylic alkyl ester (A) and a carboxyl-containing unsaturated monomer (B) as essential constitutive monomers;
the constitutive monomers constituting the acrylic emulsion polymer comprise the (meth)acrylic alkyl ester (A) in a content of from 70 to 99.5 percent by weight and the carboxyl-containing unsaturated monomer (B) in a content of from 0.5 to 10 percent by weight based on the total amount of the entire constitutive monomers; and
the acrylic emulsion polymer is polymerized with a reactive emulsifier containing at least one radically polymerizable functional group per molecule.

2. The pressure-sensitive adhesive sheet according to claim 1, wherein the resinous material constituting the base layer comprises a poly(ethylene terephthalate) or a poly(ethylene naphthalate) as a principal resinous component.

3. The pressure-sensitive adhesive sheet according to claim 1, wherein the water-dispersible removable acrylic pressure-sensitive adhesive composition further comprises a water-insoluble crosslinking agent having two or more carboxyl-reactive functional groups per molecule, the carboxyl-reactive functional groups capable of reacting with carboxyl group.

4. The pressure-sensitive adhesive sheet according to claim 1, wherein the acrylic emulsion polymer is derived from constitutive monomers comprising: the (meth)acrylic alkyl ester (A); the carboxyl-containing unsaturated monomer (B); and at least one monomer (C) selected from the group consisting of methyl methacrylate, vinyl acetate, and diethylacrylamide as essential constitutive monomers.

5. The pressure-sensitive adhesive sheet according to claim 1, wherein the acrylic emulsion polymer has a solvent-insoluble content of 70 percent by weight or more.

6. The pressure-sensitive adhesive sheet according to claim 1, wherein the acrylic pressure-sensitive adhesive layer has a solvent-insoluble content of 90 percent by weight or more and an elongation at breaking point of 130% or less at 23° C.

7. The pressure-sensitive adhesive sheet according to claim 3, wherein the carboxyl-reactive functional groups of the water-insoluble crosslinking agent are present in an amount of from 0.4 to 1.3 moles per 1 mole of carboxyl groups of the carboxyl-containing unsaturated monomer (B) in the water-dispersible removable acrylic pressure-sensitive adhesive composition.

8. The pressure-sensitive adhesive sheet according to claim 4, wherein constitutive monomers constituting the acrylic emulsion polymer comprise: 70 to 99 percent by weight of the (meth)acrylic alkyl ester (A); 0.5 to 10 percent by weight of the carboxyl-containing unsaturated monomer (B); and 0.5 to 10 percent by weight of the monomer (C), based on the total amount of the constitutive monomers.

9. The pressure-sensitive adhesive sheet according to claim 1, as a surface-protecting film for an optical member.

10. The pressure-sensitive adhesive sheet according to claim 2, wherein the water-dispersible removable acrylic pressure-sensitive adhesive composition further comprises a water-insoluble crosslinking agent having two or more carboxyl-reactive functional groups per molecule, the carboxyl-reactive functional groups

11. The pressure-sensitive adhesive sheet according to claim 2, wherein the acrylic emulsion polymer is derived from constitutive monomers comprising: the (meth)acrylic alkyl ester (A); the carboxyl-containing unsaturated monomer (B); and at least one monomer (C) selected from the group consisting of methyl methacrylate, vinyl acetate, and diethylacrylamide as essential constitutive monomers.

12. The pressure-sensitive adhesive sheet according to claim 3, wherein the acrylic emulsion polymer is derived from constitutive monomers comprising: the (meth)acrylic alkyl ester (A); the carboxyl-containing unsaturated monomer (B); and at least one monomer (C) selected from the group consisting of methyl methacrylate, vinyl acetate, and diethylacrylamide as essential constitutive monomers.

13. The pressure-sensitive adhesive sheet according to claim 2, wherein the acrylic emulsion polymer has a solvent-insoluble content of 70 percent by weight or more.

14. The pressure-sensitive adhesive sheet according to claim 3, wherein the acrylic emulsion polymer has a solvent-insoluble content of 70 percent by weight or more.

15. The pressure-sensitive adhesive sheet according to claim 2, wherein the acrylic pressure-sensitive adhesive layer has a solvent-insoluble content of 90 percent by weight or more and an elongation at breaking point of 130% or less at 23° C.

16. The pressure-sensitive adhesive sheet according to claim 3, wherein the acrylic pressure-sensitive adhesive layer has a solvent-insoluble content of 90 percent by weight or more and an elongation at breaking point of 130% or less at 23° C.

17. The pressure-sensitive adhesive sheet according to claim 4, wherein the carboxyl-reactive functional groups of the water-insoluble crosslinking agent are present in an amount of from 0.4 to 1.3 moles per 1 mole of carboxyl groups of the carboxyl-containing unsaturated monomer (B) in the water-dispersible removable acrylic pressure-sensitive adhesive composition.

18. The pressure-sensitive adhesive sheet according to claim 5, wherein the carboxyl-reactive functional groups of the water-insoluble crosslinking agent are present in an amount of from 0.4 to 1.3 moles per 1 mole of carboxyl groups of the carboxyl-containing unsaturated monomer (B) in the water-dispersible removable acrylic pressure-sensitive adhesive composition.

19. The pressure-sensitive adhesive sheet according to claim 5, wherein constitutive monomers constituting the acrylic emulsion polymer comprise: 70 to 99 percent by weight of the (meth)acrylic alkyl ester (A); 0.5 to 10 percent by weight of the carboxyl-containing unsaturated monomer (B); and 0.5 to 10 percent by weight of the monomer (C), based on the total amount of the constitutive monomers.

20. The pressure-sensitive adhesive sheet according to claim 2, as a surface-protecting film for an optical member.
